(19) United States
(12) Patent Application Publication
(10) Pub. No.: US 2026/0289382 A1
(43) Pub. Date: Sep. 24, 2026

(54) EFFICIENT LIGHTCONES FOR QUANTUM CIRCUITS

(71) Applicant: QEDMA Quantum Computing LTD., Tel-Aviv (IL)

(72) Inventors: Dorit AHARONOV, Jerusalem (IL); Omri GOLAN, Rehovot (IL); Oded KENNETH, Tel-Aviv (IL); Yotam Yona LIFSHITZ, Shimshit (IL); Netanel Hanan LINDNER, Aviel (IL); Maor SHUTMAN, Tel-Aviv (IL)

(21) Appl. No.: 19/567,801

(22) Filed: Mar. 16, 2026

Related U.S. Application Data
(60) Provisional application No. 63/774,874, filed on Mar. 20, 2025.

(51) Int. Cl. G06N 10/70; G06N 10/20

(52) U.S. Cl. CPC G06N 10/70; G06N 10/20

(57) ABSTRACT

A method is provided reducing sampling overhead of quantum error mitigation while controlling bias in an estimated observable of a quantum circuit. A lightcone is defined as a set of gates and qubits, represented as per-layer qubit subsets with associated gates. For at least one gate outside the lightcone, an operator representation of the gate is propagated forward or backward through circuit layers to obtain a propagated representation. A bias contribution is computed from the propagated representation and the observable, and bias contributions are aggregated to determine a total bias. The circuit is executed on a quantum processing unit multiple times to obtain measurement results. In classical post processing, an error mitigation protocol is applied to gates within the lightcone and omitted for gates outside the lightcone to estimate the observable for an ideal circuit. In some embodiments, nested candidate lightcones are evaluated using measurement data and one lightcone is selected.

### CROSS REFERENCE TO RELATED APPLICATIONS

This application claims priority from U.S. Provisional Patent Application No. 63/774,874 filed on the 20 Mar. 2025, which is incorporated herein by reference in its entirety.

### TECHNOLOGICAL FIELD

The present disclosure relates to the field of quantum computing, more specifically, to the field of error mitigation.

### BACKGROUND ART

References considered to be relevant as background to the presently disclosed subject matter are listed below:
[1] A. Eddins, et. al., Lightcone shading for classically accelerated quantum error mitigation, 2024, arXiv: 2409.04401.
[2] S. C. Smith, et. al., Mitigating errors in logical qubits, Communications Physics 7 386, 2024, arXiv: 2405.03766.
[3] K. Temme, et. al., Error mitigation for short-depth quantum circuits, Physical review letters 119 180509, 2017, arXiv: 1612.02058.
[4] M. C. Tran, et. al., Locality and error mitigation of quantum circuits, 2023, arXiv: 2303.06496.
[5] S. Filippov, et. al., Scalable tensor-network error mitigation for near-term quantum computing, 2023, arXiv: 2307.11740.

The indication of the above publications herein is not to be inferred as meaning that these are in any way relevant to the patentability of the presently disclosed subject matter. Especially, indication of the above publications herein is not to be inferred as meaning that these are in any way denying patentability of any presently claimed subject matter.

### BACKGROUND

A typical quantum computing (QC) process involves operating of one or more quantum gates on corresponding qubits, and typically concludes with measuring one or more qubits to obtain data from which an objective is estimated. A fundamental goal of quantum computing is to estimate the expectation value of an observable operator. In an ideal quantum computation, usually represented as a quantum circuit, the expectation value [symbol] O [symbol] of a (typically local) observable operator O generally depends only on a subset of circuit operations that can influence O under the circuit connectivity. Therefore, gates outside the “lightcone” associated with O can be removed from the circuit in quantum-classical algorithms that estimate [symbol] O [symbol] , without introducing an estimation error, known as bias. A simple example is a connectivity lightcone (ConnLC) obtained by tracing multi-qubit interactions backward from the support of O, which yields a region outside of which gates provably cannot affect [symbol] O [symbol] in the ideal circuit.

In ideal simulations, reducing the number of gates in a circuit can significantly decrease the number of arithmetic operations and the amount of memory required for state-vector simulations, tensor network (TN) contractions, and similar processes, depending on the circuit, observable, and permitted bias. Additionally, defining a lightcone for a corresponding observable enables targeted post-selection in quantum error correction. In the near term, however, error mitigation (EM) protocols are employed to estimate expectation values. EM protocols, such as Probabilistic Error Cancellation—herein referred to as Quasi-Probability (QP), effectively cancel all or part of the noise in a given circuit. However, each canceled noise channel increases the sampling overhead. Identifying noise channels that can be left unmitigated, or even made “noisier”, can drastically reduce the sampling overhead required to achieve a specified statistical error in the estimate of the observable. For example, in a QP experiment, if a noise channel acting after a gate is not mitigated, its effect is effectively squared. Therefore, it is desirable to determine which channels can be squared without causing significant bias. In some approaches, a QP experiment is executed as if all error channels are mitigated, and then, during post-processing, channels outside a selected lightcone are ignored when constructing the estimator for [symbol] O [symbol] , thereby reducing variance while controlling bias. Related work further uses ConnLC to reduce sampling overhead in QP experiments and to tighten error bounds for zero-noise extrapolation (ZNE), while motivating constructions that can be smaller than ConnLC for a given objective.

### GENERAL DESCRIPTION

In general, naive estimation methods, such as exact state-vector simulation or tensor network (TN) contraction, of the effect of quantum channels on an expectation value are generally as computationally difficult as performing the ideal quantum computation. Additionally, the number of possible subsets of gates and idle times in a given circuit can grow exponentially with the circuit volume. The simplest lightcone, known as the connectivity lightcone (herein referred to as ConnLC), is easily constructed by tracing two-qubit gates starting from the support of O. However, the ConnLC tends to expand rapidly and can often be significantly reduced. In error mitigation protocols such as quasi-probability based methods, mitigating additional noise channels may substantially increase sampling overhead and estimator variance, and therefore it is beneficial to identify channels that can be left unmitigated while remaining outside a region of influence associated with the objective and while maintaining an acceptable bias budget. Consequently, according to some embodiments thereof, the present disclosure provides efficient approximation techniques for determining one or more candidate lightcones associated with a selected objective (for examples, an observable), while maintaining reduced lightcone volume for a given or selected acceptable bias.

As used herein, an objective may include an expectation value of an observable, an energy of a Hamiltonian (including a sum of terms), a measurement outcome probability, or a mismatch metric. Considering transformation of the ideal circuit by inserting quantum channels after gates and idle times. Such quantum channels may represent, for example, removal of gates (by inserting inverses), local unitary errors, Pauli error channels, and other noise processes. This transformation may be accompanied with the question which transformations of the ideal circuit introduce a bias smaller then a selected or given bias δ>0. Specifically, such questions may be rephrased as:
(i) In an ideal circuit, what is the smallest set of gates that must be retained so that removal of the remaining gates introduces a bias of at most δ.
(ii) In a noisy circuit with associated noise channels, what is the smallest set of circuit positions (including gates and idle times) for which noise is mitigated or removed so that the bias is at most δ.

Sets that comply with the requirements of (i) and (ii) are referred herein as “active volumes”. In some embodiments, an active volume may be expressed as a set of circuit positions identified by a layer index and a qubit index. As used herein, a circuit position refers to a location in the circuit specified by at least a layer identifier and a qubit identifier, and a layer may correspond to a time slice allowing arbitrary parallelism. In some embodiments, a lightcone is represented as a binary lightcone comprising a list of per-layer qubit subsets, and an expanding lightcone comprises per-layer qubit subsets that are nested toward the objective support (for example, S₁⊆S₂⊆ . . . ⊆S_{L}⊆support(O)). A lightcone “volume” may be defined as a sum of per-layer qubit counts, enabling comparison among candidate lightcones.

According to some embodiments thereof, the technique of the present disclosure provides, an efficient iterative method for determining data on a lightcone for a selected observable O or other objective (for example, an energy estimate of a Hamiltonian, an outcome probability, or a mismatch metric) Such lightcone data may generally include a list of qubits and/or gates included in the lightcone, while other qubits and/or gates of the circuit are not considered to be a part of the lightcone. The method utilizes input data comprising data on an ideal circuit and a threshold parameter ∈≥0. In some embodiments, ϵ is selected as a bias budget and the method is configured to support statistical bias guarantees. The method further operates to determine a candidate lightcone using a layer by layer construction. Typically, the process operates backwards from qubits defining the objective (e.g., the observable O), through the layers of gates operating on qubits of the circuit, toward the initial set of qubits. Within each layer, the method identifies gates included in the lightcone and gates that can or should be omitted therefrom. Generally, the method aims to remove gates from the lightcone by testing whether boundary gates can be pushed forward outside the lightcone, at least approximately, and may utilize data on noise structure, if available, to minimize the number of gates and qubits within the lightcone or to select among candidate lightcones. In some embodiments, the lightcone is represented as a sequence of per-layer qubit sets and an associated set of gates having support fully or partially within the per-layer qubit sets. In some embodiments, the lightcone construction is configured to operate using only the ideal circuit and the parameter ϵ, without requiring a noise model.

Further, the technique of the present disclosure may utilize several efficient methods for estimating the bias associated with each candidate lightcone according to respective specific scenarios. For example, the following are non-limiting examples of the present disclosure:
LIGHTCONE-BOUNDS method, which receives an ideal circuit and a candidate lightcone and outputs bounds usable to (a) bound bias caused by removal of gates outside the lightcone and (b) bound bias due to noise channels outside the lightcone using the same bounds.
A tensor network (TN) contraction based approach for determining a bound on the bias, which in some cases provides a tighter bound at the cost of additional classical computation.
A Commutativity Lightcone determining process (COMMUTATIVITY-LC), which receives an ideal circuit, an objective (for example, an observable), and a threshold parameter ϵ≥0, and outputs an expanding lightcone constructed iteratively by testing approximate extractability of boundary gates.
NESTED LIGHTCONES processing that post-processes data from a quasi-probability (QP) error mitigation experiment, and efficiently tests validity of nested candidate lightcones in terms of mitigation bias using statistical tests, thereby selecting a lightcone candidate for use in mitigation.
A scalable subroutine for the COMMUTATIVITY-LC processing.

Generally, error mitigation techniques, for example quasi probability-based cancellation, may increase sampling cost as every additional mitigated noise channel increases the overhead and variance. The present disclosure provides a technique enabling selection of gates on which error mitigation techniques are to be applied while maintaining the observable with a bound bias and reduced variance. In some embodiments, the error mitigation is performed in classical post processing of measurement results, and a subset of gates to which the post-processing error mitigation is applied is selected based on a lightcone definition. To this end, a lightcone is defined as a collection of operations (gates and corresponding qubits) that affect the objective (observable), and may be represented as a sequence of per-layer qubits subset with corresponding gates. More specifically, a collection of gates selected such that noise affecting these gates affects the observable, and that error mitigation on these gates mitigates errors of the objective. In some embodiments, the lightcone is predetermined (for example, a connectivity lightcone), and in some embodiments the lightcone is selected or computed according to the quantum circuit and the observable. A trivial connectivity lightcone (described herein as ConnLC) is typically suitable for various applications but is often too large for efficient processing, typically requiring high overhead sampling and/or providing high variance estimator. The technique of the present disclosure provides for determining lightcones of reduced volume, maintaining an allowed bias estimation and minimizing variance.

Thus, according to a broad aspect, the present disclosure provides a method for mitigating implementation errors in measurement results of an observable Ô, the implementation errors being associated with a quantum circuit [symbol] , the method comprising:
(a) determining a total bias δ of at least one lightcone LC associated with the quantum circuit C and the observable Ô; the lightcone LC comprising:
   an ordered list of qubit-sets, the qubit-sets corresponding to consecutive gate layers included in the quantum circuit [symbol] ; and
   sets of quantum gates corresponding with the consecutive gate layers, each set of quantum gates comprising quantum gates having a respective support set of qubits comprising qubits selected from the ordered list of qubit-sets;
wherein determining the total bias δ comprises:
i) for at least one quantum gate g included in the quantum circuit [symbol] and not included in the lightcone LC, computing a gate-propagation and determining at least one propagated gate representation U, the gate-propagation being forward propagation or backward propagation; and,
ii) computing, from the propagated gate representation U and the observable Ô, a bias contribution term associated with the quantum gate g, and aggregating the bias contribution term to obtain the total bias δ;
(b) operating a quantum processing unit, and executing an implemented version of the quantum circuit [symbol] a plurality of times to obtain measurement data;
(c) measuring, in each execution, one or more qubits associated with the observable Ô to obtain respective measurement results; and
(d) processing the measurement results by applying, in classical post processing, an error mitigation protocol to determine an estimated value of the observable Ô for an ideal version [symbol] ₀ of the quantum circuit [symbol] , wherein applying the error mitigation protocol comprises applying error mitigation operations to quantum gates within the lightcone LC and omitting error mitigation operations for quantum gates outside the lightcone LC;
wherein the total bias δ is used to select the lightcone LC and/or to set at least one post processing parameter of the error mitigation protocol, and/or to set a number of executions of the quantum circuit [symbol] .

According to some embodiments, the lightcone LC is computed according to the quantum circuit [symbol] and the observable Ô by computing, for one or more quantum gates, respective bias contribution terms and selecting inclusion of at least one of: (i) a quantum gate in a gate layer and (ii) a qubit in a qubit-set of the gate layer, according to the respective bias contribution terms.

According to some embodiments, computing the gate-propagation comprises propagating an operator representation associated with the quantum gate g through one or more gate layers of the quantum circuit [symbol] to obtain the propagated gate representation U.

According to some embodiments, the operator representation associated with the quantum gate g comprises at least one of: a unitary operator corresponding to the quantum gate g, a super-operator representation of the quantum gate g, and a Pauli-basis expansion of the quantum gate g.

According to some embodiments, determining the total bias δ comprises repeating the gate-propagation and computing the bias contribution term for a plurality of quantum gates g included in the quantum circuit [symbol] and not included in the lightcone LC, and aggregating corresponding bias contribution terms to obtain the total bias δ.

According to some embodiments, aggregating the bias contribution terms comprises summing the bias contribution terms to obtain an upper bound on an absolute bias of the estimated value of the observable Ô (e.g. observable operator).

According to some embodiments, the bias contribution term associated with a quantum gate g is computed from the propagated gate representation U and the observable Ô by computing a norm of a commutator between U and Ô.

According to some embodiments, the bias contribution term associated with a quantum gate g is computed by determining a unitary B* that minimizes ∥U−I⊗B∥, and computing the bias contribution term as ∥U−I⊗B*∥, wherein I is an identity operator on qubits included in the lightcone LC.

According to some embodiments, the gate-propagation is terminated responsive to a support of the propagated gate representation U exceeding a support threshold, and wherein computing the bias contribution term comprises computing a residual term between U and an operator of the form I⊗B.

According to some embodiments, the bias contribution term is computed according to a selected norm, wherein the selected norm comprises at least one of: an operator norm, a Frobenius norm, and a trace norm.

According to some embodiments, applying the error mitigation protocol in the classical post processing comprises applying error mitigation coefficients or a mitigation map associated with quantum gates within the lightcone LC to the measurement results, and omitting application of error mitigation coefficients or mitigation map contributions associated with quantum gates outside the lightcone LC.

According to some embodiments, the error mitigation coefficients or the mitigation map are determined based on a noise model associated with the quantum processing unit.

According to some embodiments, omitting error mitigation operations for quantum gates outside the lightcone LC comprises treating one or more noise channels associated with the quantum gates outside the lightcone LC as an identity channel during the classical post processing.

According to some embodiments, the at least one post processing parameter of the error mitigation protocol comprises at least one of: selecting a candidate lightcone LC from a plurality of candidate lightcones, selecting a bias threshold δₘₐₓ, selecting a variance target, selecting a truncation parameter of the error mitigation protocol, and selecting a regularisation parameter of the error mitigation protocol.

According to some embodiments, selecting the lightcone LC comprises selecting, among a plurality of candidate lightcones, a candidate lightcone having a smallest estimated variance subject to the total bias δ satisfying a bias criterion.

According to some embodiments, the bias criterion comprises δ≤δₘₐₓ.

According to some embodiments, the lightcone LC comprises at least one boundary quantum gate having a support that includes at least one qubit included in a qubit-set of the lightcone LC at a gate layer and at least one qubit excluded from the qubit-set at said gate layer.

According to some embodiments, determining the total bias δ comprises iterating over boundary quantum gates and computing the gate-propagation for each iterated boundary quantum gate.

According to one other broad aspect, the present disclosure provides a computer-implemented method for determining bias associated with a reduced influence region of a quantum circuit, the method comprising:
(a) receiving circuit data describing a quantum circuit including a plurality of layers and a plurality of quantum gates acting on qubits;
(b) receiving objective data indicative of an objective evaluated using measurement results of the quantum circuit;
(c) receiving lightcone data defining a candidate lightcone of the quantum circuit, the candidate lightcone including:
(i) an ordered list of per-layer qubit sets corresponding to consecutive layers of the quantum circuit; and
(ii) per-layer sets of quantum gates, each per-layer set including quantum gates having support on at least one qubit of the corresponding per-layer qubit set;
(d) for at least one quantum gate that is outside the candidate lightcone or is a boundary gate of the candidate lightcone, computing a propagated representation of the quantum gate by propagating a representation associated with the quantum gate through one or more subsequent layers and/or one or more preceding layers; and
(e) determining, for the at least one quantum gate, a bias contribution term as a function of the propagated representation and the objective.

In some embodiments, the method may further comprise (f) determining a total bias estimate or a total bias bound for the candidate lightcone based on an aggregation of bias contribution terms computed for a plurality of quantum gates.

According to some embodiments, the objective comprises an expectation value of an observable operator, an energy estimate of a Hamiltonian term or sum of terms, a measurement outcome probability, or a mismatch metric derived from measurement results.

According to some embodiments, the candidate lightcone is represented as a sequence of per-layer qubit sets that varies in size across layers such that the lightcone contracts toward a measurement layer when viewed forward in circuit time.

According to some embodiments, computing the propagated representation comprises forward propagation through subsequent layers while applying only gates that (i) are included in the candidate lightcone for the corresponding layer and (ii) intersect a current support of the propagated representation.

According to some embodiments, computing the bias contribution term comprises, when propagation reaches an end of the quantum circuit, computing a norm of a commutator between the propagated representation and the objective.

According to some embodiments, computing the bias contribution term comprises, when propagation is halted before reaching an end of the quantum circuit, computing a residual between the propagated representation and an operator having an identity component on qubits inside the candidate lightcone and an operator component on qubits outside the candidate lightcone.

According to some embodiments, propagation is halted when a support size of the propagated representation exceeds a support-size limit.

According to some embodiments, the bias contribution term is computed using at least one norm selected from an operator norm, a Frobenius norm, and a trace norm.

According to some embodiments, the method further comprising ranking gates according to the bias contribution terms, thereby producing non-binary lightcone influence data.

According to some embodiments, the at least one quantum gate is a boundary gate whose support includes (i) at least one qubit included in a per-layer qubit set of the candidate lightcone and (ii) at least one qubit excluded from that per-layer qubit set.

According to some embodiments, the method further comprising computing a plurality of candidate lightcones and computing a corresponding plurality of total bias estimates or total bias bounds, and selecting a candidate lightcone based on a selection criterion comprising at least one of: a minimum total bias bound, a minimum mitigation overhead subject to a bias constraint, or a minimum runtime subject to a confidence criterion.

According to some embodiments, the method further comprising computing an error bar or confidence interval for the total bias estimate or total bias bound based on statistical analysis of sampled data associated with the bias contribution terms.

According to another broad aspect, the present disclosure provides a computer-implemented method for mitigating implementation errors in measurement results of a quantum circuit, the method comprising:
(a) receiving circuit data describing the quantum circuit;
(b) receiving objective data indicative of an objective evaluated using measurement results of the quantum circuit;
(c) determining, using one or more processors, a lightcone associated with the objective by:
(i) computing bias contribution terms for a plurality of gates outside a connectivity lightcone or on a boundary of a candidate lightcone using propagation of a representation associated with each respective gate; and
(ii) selecting inclusion of at least one gate and/or at least one qubit in the lightcone based on the bias contribution terms;
(d) selecting, based on at least one computed total bias estimate or total bias bound, a subset of circuit operations for which an error-mitigation protocol is to be applied;
(e) executing the quantum circuit on a quantum processing unit while applying the error-mitigation protocol to circuit operations included in the selected subset;
(f) measuring qubits to obtain measurement results; and
(g) processing the measurement results to generate an estimate of the objective corresponding to an ideal version of the quantum circuit.

According to some embodiments, the error-mitigation protocol comprises a quasi-probability protocol.

According to some embodiments, selecting the subset comprises selecting operations inside the lightcone and excluding operations outside the lightcone.

According to some embodiments, the method comprising computing a plurality of nested candidate lightcones ordered by inclusion, and selecting one of the nested candidate lightcones using a statistical validation procedure that evaluates a bias-variance tradeoff under a confidence criterion.

According to some embodiments, the statistical validation method selects, from a plurality of candidate lightcones, a lightcone that is expected to minimize an error metric that combines bias and variance of an estimator computed from measurement data produced by running an error-mitigation experiment. In some embodiments, the error metric comprises a mean squared error term including an estimated squared bias term and an estimated variance term.

According to some embodiments, the statistical validation method selects a candidate lightcone by minimizing an estimated variance of an estimator, subject to a bias criterion being selected or predetermined, based on measurement data produced by running an error mitigation experiment. In some embodiments, for each candidate lightcone the method operates (i) to determine an estimated bias attributable to excluding operations outside the candidate lightcone and (ii) to determine an estimated variance of an estimator produced using error mitigation restricted to the candidate lightcone, and to select, among candidate lightcones that satisfy the bias criterion, the candidate lightcone having the smallest estimated variance. In some embodiments, the bias criterion comprises a bias threshold, a bias budget, or a confidence bound on bias.

According to some embodiments, processing the measurement results comprises applying a decision rule that outputs one of: accept a candidate lightcone, reject a candidate lightcone, or acquire additional samples.

According to another broad aspect, the present disclosure provides a method for mitigating implementation errors in measurement results of an observable Ô, the implementation errors being associated with a quantum circuit [symbol] , the method comprising:
(a) determining a total bias δ of at least one lightcone LC associated with a quantum circuit [symbol] and an observable Ô; the lightcone LC comprising:
   an ordered list of qubit-sets, the qubit-sets corresponding with consecutive gate layers included in the quantum circuit [symbol] ; and
   sets of quantum gates corresponding with the consecutive gate layers, each set of quantum gates comprising quantum gates having a respective support set of qubits comprising qubits selected from the ordered list of qubit-sets;
wherein determining the total bias δ comprises processing:
i) a gate-propagation for at least one quantum gate g included in the quantum circuit [symbol] and not included in the lightcone LC and determining at least one propagated gate U, the gate-propagation being any one of: forward propagation and backward propagation; and,
ii) the total bias δ of the observable Ô as a function of the at least one propagated gate U;
(b) executing error mitigation on quantum gates included in the lightcone LC according to an error mitigation protocol;
(c) measuring at least one qubit associated with the observable Ô, and obtaining measurement results; and
(d) processing the measurement results, and determining an estimate value of the observable Ô, associated with an ideal version [symbol] ₀ of the quantum circuit [symbol] ;
wherein any one of the: executing error mitigation, measuring at least one qubit, and processing the measurement results, is performed according to the total bias δ.

According to some embodiments, the method further comprising computing a corresponding bias contribution term η_{g}, as a function of said at least one propagated gate U; and, computing said at least one lightcone LC according to said quantum circuit [symbol] and said observable Ô, wherein computing the at least one lightcone LC comprises:
(a) computing a gate-propagation for at least one quantum gate g included in said quantum circuit [symbol] , and determining a corresponding at least one propagated gate U, said gate-propagation being any one of: forward propagation and backward propagation;
(b) computing a corresponding bias contribution term η_{g}, as a function of said at least one propagated gate U; and
(c) selecting, according to said corresponding bias contribution term η_{g}, inclusion in said lightcone LC of:
   said at least quantum operation g, in a set of quantum gates corresponding a gate layer including said at least one quantum gate g, thereby selecting inclusion of said at least quantum operation g in said lightcone LC; and
   at least one qubit included in a support of said at least quantum operation g, in a qubit-set being corresponding said gate layer including said at least one quantum gate g.

According to some embodiments, the method further comprising:
(e) computing a total bias δ of said observable Ô as a function of said corresponding bias contribution term η_{g}; and,
(f) computing an error-bar associated with said total bias δ.

According to some embodiments, the gate-propagation being computed for an ideal version g₀ of said at least one quantum gate g.

According to some embodiments, the total bias δ being computed according to an ideal version [symbol] ₀ of said quantum circuit [symbol] .

According to some embodiments, the gate-propagation being computed for an ideal version g₀ of said at least one quantum gate g, and wherein said lightcone LC being computed according to an ideal version [symbol] ₀ of said quantum circuit [symbol] .

According to some embodiments, the method further comprises:
(g) said corresponding bias contribution term η_{g} being:
   i) ∥U−A*⊗B*∥ if said gate-propagation being performed with respect to the propagated gate U having an associated layer index l being greater than one and less than a depth L of said quantum circuit [symbol] , thereby 1<l<L;
   ii) ∥[U, Ô]∥ if said gate-propagation being performed forward with respect to the associated layer index l being equal to said depth L; or
   iii) ∥[ρ₀, Ô]∥ if said gate-propagation being performed backwards with respect to the associated layer index l being equal to one, wherein po being an initial state of a qubit support of said quantum circuit C;
(h)

$${A}^{*} ⊗ {B}^{*} = {argmin}_{\{ B \} \times \{ A \}} ‖ U - A ⊗ B ‖ ,$$

wherein A being a unitary having support included in said lightcone LC, and B being a unitary having support not included in said lightcone LC;
(i) norms preferably being any one of: an operator norm, Frobenius norm, and trace norm; and
(j) a qubit-support of B being non-overlapping with a qubit-set corresponding gate layer l+1 and included in said lightcone LC.

According to some embodiments, the method further comprises:
(k) said corresponding bias contribution term η_{g} being:
   i) ∥U−I⊗B*∥ if said gate-propagation being performed with respect to the propagated gate U having an associated layer index l being greater than one and less than a depth L of said quantum circuit [symbol] , thereby 1<l<L;
   ii) ∥[U, Ô]∥ if said gate-propagation being performed forward with respect to the associated layer index l being equal to said depth L; or
   iii) ∥[ρ₀, Ô]∥ if said gate-propagation being performed backwards with respect to the associated layer index l being equal to one, wherein po being an initial state of a qubit support of said quantum circuit [symbol] ;
(l)

$${B}^{*} = {argmin}_{\{ B \}} ‖ U - I ⊗ B ‖ ,$$

wherein I being a unit matrix having support included in said lightcone LC, and B being a unitary having support not included in said lightcone LC;
(m) norms preferably being any one of: an operator norm, Frobenius norm, and trace norm; and
(n) a qubit-support of B being non-overlapping with a qubit-set corresponding gate layer l+1 and included in said lightcone LC.

According to some embodiments, quantum gates included in said lightcone LC being any one of: ideal, and implemented according to a error-mitigation protocol (e.g., being effectively ideal); the method comprising computing an external bias contribution term ηₑₓₜ being associated with at least one quantum gate being not included in said lightcone LC; and, wherein said external bias contribution term ηₑₓₜ being a weighted sum of norms

$${η}_{ext} = {\sum }_{k , l , m} {p}_{k}^{( l , m )} ‖ {ℰ}_{k}^{( l , m )} {𝒰}_{l + 1} … {𝒰}_{L} ( \hat{O} ) - {𝒰}_{l + 1} … {𝒰}_{L} ( \hat{O} ) ‖ ,$$

wherein:
i) l indexes gate layers, m indexes quantum gates included in a gate layer l and not included in said light cone LC, k indexes error terms included in an error channel associated with a quantum gate indexed by l, m;
ii) L being a depth of said quantum circuit [symbol] ,

$${𝒰}_{l}^{†}$$

being an action of quantum gates included in layer l,

$${ε}_{k}^{( l , m )}$$

being a unitary error term included in said error channel associated with said quantum gate indexed by l, m,

$${p}_{k}^{( l , m )}$$

being a probability for

$${ε}_{k}^{( l , m )}$$

to be an effect of said error channel; and
iii) the norm preferably being any one of: an operator norm, Frobenius norm, and trace norm.

According to some embodiments, the total bias δ being δ=∥( [symbol] − [symbol] ^{†})(Ô)∥, where [symbol] being an identity super-operator, [symbol] ^{†}= [symbol] ^{†} [symbol] ^{†}, [symbol] ^{†} being an action of a non-ideal implementation of said quantum circuit [symbol] , [symbol] ^{†} being an action of said ideal version [symbol] ₀ of said quantum circuit [symbol] ; and, wherein the method comprising tensor contraction of [symbol] ^{†}.

According to some embodiments, for at least one quantum gate Q, a qubit-set, corresponding a gate layer including said at least one quantum operation Q, being:
(o) comprising at least one qubit included in a support of said at least one quantum operation Q; and
(p) excluding at least one qubit included in a support of said at least one quantum operation Q;
thereby, said lightcone LC comprises a qubit-set comprising qubits corresponding at least one boundary quantum gate, thereby, a boundary of said lightcone LC intersects said at least one quantum gate Q.

According to some embodiments, the at least one quantum gate g being a non-Clifford gate.

According to some embodiments, the method further comprises:
(q) said at least one quantum gate g is included in a predefined lightcone being a connectivity light cone;
(r) a connectivity between qubits comprises connections according to a noise model A associated with a quantum processing unit and said quantum circuit [symbol] ;
(s) a support of said at least one quantum gate g being partially included in at least one qubit-set corresponding a gate layer succeeding a gate layer comprising said at least one quantum gate g; and,
(t) the method comprising iterating over boundary quantum gates, and computing propagation for each boundary quantum gate being iterated over.

According to some embodiments, an error channel Λ associated with said at least one quantum gate g being non-Hermitian.

According to some embodiments, selecting the lightcone LC comprises:
determining a plurality of candidate lightcones LC^{(j)} associated with the quantum circuit [symbol] and the observable Ô;
wherein, for at least a first candidate lightcone LC^{(j)} and a second candidate lightcone LC^{(k)}, all quantum gates included in LC^{(j)} are included in LC^{(k)}, thereby the first candidate lightcone LC^{(j)} being nested in the second candidate lightcone LC^{(k)}; and
selecting the lightcone LC from the plurality of candidate lightcones.

According to some embodiments, the plurality of candidate lightcones LC^{(j)} are nested such that, for each of a plurality of consecutive gate layers, a qubit-set of LC^{(j)} is a subset of a corresponding qubit-set of LC^{(k)}.

According to some embodiments, the method may further comprise, for each candidate lightcone LC^{(j)}, processing the measurement results by applying the error mitigation protocol to quantum gates within LC^{(j)} and omitting error mitigation operations for quantum gates outside LC^{(j)} thereby determining a respective estimated value of the observable Ô using the same measurement results.

According to some embodiments, selecting the lightcone LC comprises:
identifying a difference region between a reference lightcone LC_{ref} and a candidate lightcone LC_{cand}, the difference region including circuit positions that are inside the reference lightcone LC_{ref} and outside the candidate lightcone LC_{cand}; and
estimating a quantitative bias contribution associated with the difference region using a common quasi-probability dataset.

According to some embodiments, the common quasi-probability dataset comprises, for each shot:
(i) an indication of which quasi-probability-modified circuit instance was executed; and
(ii) a corresponding measurement outcome.

According to some embodiments, selecting the lightcone LC comprises selecting, among the plurality of candidate lightcones LC^{(j)} a candidate lightcone having a smallest estimated variance subject to a total bias satisfying a bias criterion.

According to some embodiments, the bias criterion comprises δ≤δₘₐₓ.

According to some embodiments, the method further comprises, for a pair of nested candidate lightcones LC^{(j)}⊂LC^{(k)}, selecting the lightcone LC comprises evaluating a contribution associated with quantum gates included in LC^{(k)} and excluded from LC^{(j)} and selecting according to a change in estimated variance and a change in total bias attributable to said quantum gates.

According to yet another broad aspect, the present disclosure provides a method for mitigating implementation errors in measurement results of an observable Ô, the implementation errors being associated with a quantum circuit [symbol] , the method comprising:
determining a plurality of candidate lightcones LC^{(j)} associated with the quantum circuit C and the observable Ô, each candidate lightcone LC^{(j)} comprising:
an ordered list of qubit-sets, the qubit-sets corresponding to consecutive gate layers included in the quantum circuit [symbol] ; and
sets of quantum gates corresponding with the consecutive gate layers, each set of quantum gates comprising quantum gates having a respective support set of qubits comprising qubits selected from the ordered list of qubit-sets;
wherein the plurality of candidate lightcones LC^{(j)} comprise at least a first candidate lightcone LC^{(j)} and a second candidate lightcone LC^{(k)} such that all quantum gates included in the first candidate lightcone LC^{(j)} are included in the second candidate lightcone LC^{(k)}, thereby the first candidate lightcone LC^{(j)} being nested in the second candidate lightcone LC^{(k)};
operating a quantum processing unit, and executing an implemented version of the quantum circuit [symbol] a plurality of times to obtain measurement data;
measuring, in each execution, one or more qubits associated with the observable Ô to obtain respective measurement results;
for each candidate lightcone LC^{(j)} processing the measurement results by applying, in classical post processing, an error mitigation protocol to determine a respective estimated value of the observable Ô for an ideal version [symbol] 0 of the quantum circuit [symbol] , wherein applying the error mitigation protocol comprises applying error mitigation operations to quantum gates within the candidate lightcone LC^{(j)} and omitting error mitigation operations for quantum gates outside the candidate lightcone LC^{(j)};
for each candidate lightcone LC^{(j)} determining an estimated variance and a total bias associated with the respective estimated value; and
selecting a selected lightcone from the plurality of candidate lightcones LC^{(j)} by minimising the estimated variance subject to the total bias satisfying a bias criterion, and outputting the respective estimated value associated with the selected lightcone.

According to some embodiments, the candidate lightcones LC^{(j)} are nested such that, for each of a plurality of consecutive gate layers, a qubit-set of LC^{(j)} is a subset of a corresponding qubit-set of LC^{(k)}.

According to some embodiments, the bias criterion comprises δ≤δₘₐₓ.

According to some embodiments, determining the respective estimated values for the plurality of candidate lightcones LC^{(j)} is performed using the same measurement results obtained from executing the implemented version of the quantum circuit [symbol] .

According to some embodiments, for a pair of candidate lightcones LC^{(j)} and LC^{(k)} satisfying LC^{(j)} ⊂LC^{(k)}, the method identifies a difference region including circuit positions that are inside LC^{(k)} and outside LC^{(j)} and estimates a quantitative bias contribution associated with the difference region using a common quasi-probability dataset.

According to a further broad aspect, the present disclosure provides a system for operating a quantum computer, the system comprising:
a) a quantum processing unit comprising one or more qubits and configured to execute quantum circuits and perform measurement shots to generate measurement results; and
b) a classical control system communicatively coupled to the quantum processing unit, the classical control system comprising one or more processors and one or more memories storing instructions that, when executed by the one or more processors, cause the classical control system to:
determine a total bias δ of at least one lightcone LC associated with a quantum circuit [symbol] and an observable Ô, the lightcone LC comprising:
   an ordered list of qubit-sets, the qubit-sets corresponding to consecutive gate layers included in the quantum circuit [symbol] ; and
   sets of quantum gates corresponding with the consecutive gate layers, each set of quantum gates comprising quantum gates having a respective support set of qubits comprising qubits selected from the ordered list of qubit-sets;
wherein determining the total bias δ comprises:
for at least one quantum gate g included in the quantum circuit [symbol] and not included in the lightcone LC, compute a gate-propagation and determine at least one propagated gate representation U, the gate-propagation being forward propagation or backward propagation; and
compute, from the propagated gate representation U and the observable Ô, a bias contribution term associated with the quantum gate g, and aggregate the bias contribution term to obtain the total bias δ;
operate the quantum processing unit to execute an implemented version of the quantum circuit [symbol] a plurality of times to obtain measurement data;
measure, in each execution, one or more qubits associated with the observable Ô to obtain respective measurement results;
process the measurement results by applying, in classical post processing, an error mitigation protocol to determine an estimated value of the observable Ô for an ideal version [symbol] ₀ of the quantum circuit [symbol] , wherein applying the error mitigation protocol comprises applying error mitigation operations to quantum gates within the lightcone LC and omitting error mitigation operations for quantum gates outside the lightcone LC; and
use the total bias δ to select the lightcone LC and/or to set at least one post processing parameter of the error mitigation protocol, and/or to set a number of executions of the quantum circuit C.

According to another broad aspect, the present disclosure provides a method for mitigating implementation errors in measurement results of an observable O, the implementation errors being associated with a quantum circuit C, the method comprising:
(a) computing at least one lightcone LC according to the quantum circuit Cand the observable O according to a method of claim 2;
(b) executing quantum gates included in the lightcone LC according to an error-mitigation protocol;
(c) measuring at least one qubit associated with the observable O to obtain measurement results; and

(d) processing the measurement results to obtain an estimated value of the observable O associated with an ideal version C₀ of the quantum circuit C.

According to another broad aspect, the present disclosure provides a method for mitigating implementation errors in measurement results of an observable O, the implementation errors being associated with a quantum circuit C, the method comprising:
(a) executing at least one quantum gate included in the quantum circuit C according to an error-mitigation protocol;
(b) measuring at least one qubit associated with the observable Oto obtain measurement results; and
(c) processing the measurement results to obtain an estimated value of the observable O associated with an ideal version C₀ of the quantum circuit C,
wherein the processing comprises computing at least one lightcone LC according to a method of claim 2.

According to some embodiments, the method further comprises executing the quantum circuit C.

According to some embodiments, the method further comprises measuring all qubits associated with the observable O.

According to another broad aspect, the present disclosure provides a method for mitigating implementation errors in measurement results of an observable O, the implementation errors being associated with a quantum circuit C, the method comprising:
(a) computing a total bias S of at least one predetermined lightcone LC according to the quantum circuit C and the observable O according to a method of claim 1;
(b) executing quantum gates included in the lightcone LC according to an error-mitigation protocol;
(c) measuring at least one qubit associated with the observable Oto obtain measurement results; and
(d) processing the measurement results to obtain an estimated value of the observable O associated with an ideal version C₀ of the quantum circuit C.

According to some embodiments, the method further comprises computing a plurality of total-bias values corresponding to a plurality of lightcones, and selecting a lightcone according to a minimum corresponding bias (or minimum corresponding bias bound).

According to some embodiments, the error-mitigation protocol comprises canceling errors for operations included in the at least one lightcone LC.

According to some embodiments, the error-mitigation protocol comprises canceling errors only for operations included in the at least one lightcone LC.

According to some embodiments, the error-mitigation protocol comprises quasi-probability decomposition and/or tensor error mitigation.

According to some embodiments, the method may be performed for a plurality of observables.

According to another broad aspect, the present disclosure provides a quantum processing unit, comprising:
(a) at least two qubits;
(b) at least one pulse generator coupled to the at least two qubits, to apply pulses to the at least two qubits; and
(c) a controller communicating with the at least one pulse generator to provide commands to the at least one pulse generator;
wherein the quantum processing unit is configured to implement the method described herein above.

According to some embodiments, the at least one pulse generator is configured to apply radiofrequency pulses.

According to some embodiments, the at least two qubits are superconducting qubits.

According to some embodiments, the at least one pulse generator is configured to apply infrared pulses, visible light pulses, and/or ultraviolet pulses.

According to another broad aspect, the present disclosure provides a system comprising a computer and a quantum processing unit, the computer having pulse-level access to the quantum processing unit, the system being configured to implement the method described herein above.

According to another broad aspect, the present disclosure provides a non-transient computer readable storage medium, storing computer instructions, wherein the computer instructions are used for causing a computer communicating with a quantum processing unit, to implement the method as described herein.

According to another broad aspect, the present disclosure provides a non-transitory computer-readable storage medium storing instructions that, when executed by at least one processor, cause the at least one processor to perform the method as described herein.

According to another broad aspect, the present disclosure provides a computer-implemented method comprising simulating performance of the method as described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a light cone within a quantum circuit diagram;

FIG. 2 exemplifies a method according to some embodiments of the present disclosure utilizing determining bound of a bias;

FIG. 3 exemplifies a flowchart schematically illustrating a method use in error mitigation according to some embodiments of the present disclosure;

FIG. 4 schematically illustrates a nested light cone according to some embodiments of the present disclosure;

FIG. 5 schematically illustrates a light cone for a Transverse Field Ising Model (TFIM) circuit according to some embodiments of the present disclosure;

FIGS. 6A to 6D show simulation results exemplifying selection of lightcones in accordance with a bound on the respective bias and variance associated therewith;

FIG. 7 shows aggregated simulation results across multiple Trotter circuits and observables, showing performance of method for selection between nested lightcones at scale according to some embodiments of the present disclosure;

FIG. 8 schematically illustrates intersecting lightcones J₊(ξ)∩J₋(O) defining regions of restricted circuit effects according to some embodiments of the present disclosure;

FIG. 9 schematically illustrates the basic randomized propagation/compression step according to some embodiments of the present disclosure; and

FIG. 10 schematically illustrate an objective operator O that may become entangled, under backward propagation according to some embodiments of the present disclosure.

### DETAILED DESCRIPTION OF EMBODIMENTS

The present disclosure uses a lightcone to identify parts of a quantum circuit that influence a specified objective at the circuit's output, and, in some embodiments, to identify circuit operations whose omission or unmitigated noise is expected to contribute at most a selected bias to the objective. The objective may include, for example, an expectation value of an observable, an energy estimate of a Hamiltonian (including a sum of terms), a measurement outcome probability, or a mismatch metric derived from measurement results. A baseline lightcone, sometimes referred to as a connectivity lightcone, may be obtained by tracing backward from the support of the objective through multi-qubit operations. In practice, that connectivity-based construction often expands quickly and includes circuit portions that have little practical impact on the objective for a selected bias budget. The techniques described below therefore, in some embodiments thereof, provide determining a reduced lightcone that approximates an active volume: a subset of circuit positions, gates, and qubits that is sufficient to preserve the objective within a user-selected tolerance (for example, a bias budget δ or ϵ, optionally with a statistical confidence level).

Generally, a quantum circuit, or model thereof, useable with the technique of the present disclosure may typically include a selected number of layers, each including one or more gates, selected from single qubit gate, two-qubit gate, and idle time (no operation within the layer). The circuit may operate on a selected number of qubits and propagate the qubits from an initial state (typically initiated at ground state, but not necessarily) toward the objective layer.

In some embodiments, a lightcone is determined/constructed iteratively through a quantum circuit, on a layer-by-layer basis using an extractability or commutativity based rule. A layer may correspond to a time slice allowing arbitrary parallelism. The construction proceeds backward from the objective/measurement layer toward the circuit start, maintaining a sequence of per-layer qubit sets. At each step, the method may identify boundary gates whose support intersects the current lightcone but is not fully contained within it. As used herein, a boundary gate may be included in a set of boundary gates (denoted, for example, ∂LC), where ∂LC includes gates whose support includes at least one qubit inside the lightcone and at least one qubit outside the lightcone. For each such boundary gate, an approximate extractability test is performed by propagating a representation of the boundary gate forward through later gates that lie within the current lightcone and intersect the propagated support. The propagated representation may be evaluated using one or more criteria indicating that the boundary gate can be treated as effectively outside the lightcone, for example by approximately commuting with the objective at the end of the circuit or by being well approximated by an operator of the form I⊗B where I is an identity operator acting on qubits inside the lightcone and B is an operator acting on qubits outside the lightcone. When the boundary gate is not approximately extractable under a threshold parameter ϵ, the lightcone is expanded by adding at least one qubit of the boundary gate that is outside the current lightcone, thereby producing an expanding lightcone when viewed backward in time and a contracting influence region when viewed forward toward measurement. In some embodiments, the lightcone construction is performed using the ideal circuit and ϵ, without requiring an explicit noise model.

Once a lightcone is available, it can be used in at least two complementary ways as described in more detail below. In error mitigation workflows, mitigating noise on every circuit operation can lead to variance blow-up and high sampling overhead, particularly for quasi-probability style techniques. By restricting mitigation to operations inside a selected lightcone and leaving operations outside the lightcone unmitigated, the technique of the present disclosure enables a controlled bias while materially reducing estimator variance, and in some embodiments supports selecting among candidate (including nested) lightcones using statistical validation. In classical simulation, operations outside a sufficiently justified lightcone may be omitted or otherwise approximated so that simulation is performed on a reduced circuit volume, reducing memory and arithmetic cost while meeting a target bias budget for the objective. The following sections describe example lightcone representations, construction procedures, bias estimation and bounding techniques, and example workflows for lightcone-guided error mitigation and lightcone-guided simulation, including variants that support mid-circuit measurement and related operations.

In the following detailed description, numerous specific details are set forth in order to provide a thorough understanding of the subject matter. However, it will be understood by those skilled in the art that some examples of the subject matter may be practiced without these specific details. In other instances, well-known methods, procedures and components have not been described in detail for simplicity.

As used herein, the phrases “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “computing”, “determining”, “running”, “implementing”, “using”, “performing”, or the like, may refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

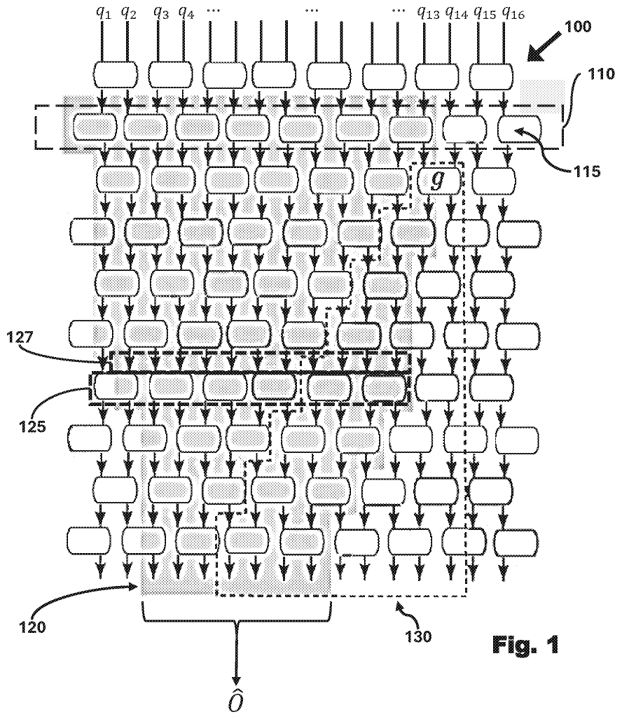

FIG. 1 illustrates a quantum circuit 100 arranged as a sequence of circuit layers, where each layer corresponds to a time slice that may include arbitrary parallelism among gates acting on different qubits. FIG. 1 shows an exemplary circuit layer 110 as one such layer of the quantum circuit 100, including gates within the lightcone and an exemplary boundary gate g. Time progresses through the layers toward a final measurement layer, at which an objective Ô is evaluated, such as an expectation value of an observable, an energy estimate of a Hamiltonian, a measurement outcome probability, or a mismatch metric.

A typical lightcone 120 is indicated in FIG. 1 as a shaded region spanning a subset of circuit positions across multiple layers of the quantum circuit 100. The lightcone 120 represents qubits and gates treated as relevant to the specified objective at the circuit output. Gates whose support lies within the lightcone 120 are treated as inside the lightcone, while gates outside the lightcone 120 are treated as outside the lightcone for purposes such as restricted error mitigation or reduced simulation, subject to a selected bias budget. In some embodiments, a gate is treated as inside the lightcone when all qubits acted on by the gate are in the per-layer qubit set for the corresponding layer, and a boundary gate is treated as partially overlapping the lightcone when the gate acts on at least one qubit in the per-layer qubit set and at least one qubit outside the per-layer qubit set.

Boundary gate g, is defined as a multi-qubit gate whose support overlaps the boundary of the lightcone 120. In the illustrated example, gate g lies at the boundary because it interacts with at least one qubit inside the lightcone 120 and at least one qubit outside the lightcone 120. For such a boundary gate g, the lightcone construction procedure evaluates whether the gate g can be treated as approximately extractable with respect to the objective, for example by propagating a representation associated with the gate g forward through later gates of the quantum circuit 100 that lie within the lightcone 120 and intersect the propagated support. In some embodiments, the propagation is performed in the Heisenberg picture by updating an operator representation associated with g as it is pushed forward through later circuit operations.

FIG. 1 also exemplifies brute-force propagation of the boundary gate g, illustrated by a dashed line region 130. In particular, when evaluating whether the boundary gate g is approximately extractable, a representation associated with gate g can be propagated forward through subsequent layers, and the support of that representation may expand as it interacts with later multi-qubit gates. The brute-force propagation region 130 schematically indicates the circuit positions that may be reached during brute-force propagation of the boundary gate g, and is therefore used to bound the gates and qubits considered in the propagation and the corresponding extractability test. In some embodiments, during propagation, gates outside the lightcone 120 are ignored, while gates inside the lightcone 120 that intersect the current support of the propagated representation are applied, which may cause the support to grow within a region bounded by circuit connectivity.

Following the discussion of FIG. 1, and in particular the brute-force propagation of the boundary gate g within the dashed line region 130, the present disclosure describes a Lightcone-Bounds procedure for quantifying how much a candidate lightcone 120 can be reduced while maintaining a selected bias budget. In some embodiments, the procedure receives as inputs a quantum circuit (for example, the quantum circuit 100), an objective operator O (for example, an observable or Hamiltonian term whose expectation value is of interest), and a candidate lightcone 120. The procedure produces, for circuit operations that are not included in the lightcone (and in some cases for boundary-related operations), a set of per-operation bounds that can be combined to obtain a total bias estimate or bias bound for the candidate lightcone. In some embodiments, the Lightcone-Bounds procedure focuses on boundary gates in ∂LC, since gates that do not intersect the lightcone do not contribute to the bound for objectives supported on the lightcone.

In some embodiments, the Lightcone-Bounds procedure operates by processing a gate g (identified together with its layer index) using a brute-force propagation routine that propagates a representation U associated with gate g forward through subsequent layers. During propagation, gates outside the lightcone 120 are ignored, while gates inside the lightcone 120 that intersect the current support of U are applied to update U, which may cause the support of U to grow. The dashed line region 130 in FIG. 1 corresponds to the region that may be reached by such propagation under circuit connectivity, and therefore bounds which later circuit positions can become relevant to the propagation of gate g. To manage classical complexity, propagation may be halted if the support of U exceeds a selected maximum support size maxsupp (a tunable parameter controlling a tradeoff between computation cost and tightness of the resulting bound). In some embodiments, the Lightcone-Bounds procedure outputs a list of tuples, each tuple including a bound value (for example, η_{g}), the corresponding gate g, and the layer index of g. In some embodiments, a norm is used in computing the bound, including an operator norm providing a worst-case bound over initial states and a normalized Frobenius norm providing an average-case bound that may more closely track practical bias for typical initial states.

When propagation reaches the end of the circuit, the contribution of gate g can be bounded using a commutator-based quantity, for example by evaluating a norm of a commutator [U, Ô], where [U, Ô]=UÔ−ÔU and the norm may be an operator norm or a normalized Frobenius norm. When propagation is halted before reaching the end of the circuit (for example due to the maxsupp condition), the contribution of gate g can instead be bounded using an extractability residual: in some embodiments, an operator B is selected to minimize a distance between U and an operator of the form I⊗B, where I is an identity operator acting on qubits inside the lightcone and B acts on qubits outside the lightcone, and the resulting minimum distance (under the selected norm) is used as the bound associated with gate g. The Lightcone-Bounds procedure outputs, for example, a list of tuples associating each processed gate (and its layer index) with its computed bound, which may then be summed, weighted, ranked, or otherwise aggregated to bound the bias introduced by omitting operations outside the lightcone or by leaving noise channels outside the lightcone unmitigated. In some embodiments, the total bias bound is obtained as a sum of the per-gate bound values for boundary gates, and the per-gate bound values are used to rank gates or circuit positions by estimated contribution to bias.

In this connection, determining a bound, or bounding, the bias induced on an observable by deleting all gates outside an expanding lightcone may be based on the following.

Considering O as a unitary observable, such as a Pauli operator, and assuming [symbol] ⱼ as the part of [symbol] ⱼ that is contained in the lightcone at layer j. For simplicity, the notation [symbol] _{i:j}= [symbol] . . . [symbol] ⱼ, and similarly [symbol] _{i:j} is used herein, providing:

$$\vert 〈 {ρ}_{0} , {𝒰}_{1 : L} ( 0 ) 〉 - {ρ}_{0} , {\tilde{𝒰}}_{1 : L} ( 0 ) \vert = ‖ ( {𝒰}_{1 : L} - {\tilde{𝒰}}_{1 : L} ) ( 0 ) ‖$$

using the Hölder inequality for Schatten norms. From here, using the telescopic identity:

$${𝒰}_{1 : ℒ} - {\tilde{𝒰}}_{1 : ℒ} = {\sum }_{k = 1}^{L} c {U}_{1 : k - 1} ( {𝒰}_{k} - {\tilde{𝒰}}_{k} ) {\tilde{𝒰}}_{k + 1 : ℒ} ,$$

Provides the bound

$$‖ ( {𝒰}_{1 : ℒ} - {\tilde{𝒰}}_{1 : ℒ} ) ( 0 ) ‖ \leq {\sum }_{k = 1}^{L} ‖ {𝒰}_{1 : k - 1} ( {𝒰}_{k} - {\tilde{𝒰}}_{k} ) {\tilde{𝒰}}_{k + 1 : ℒ} ( 0 ) ‖ .$$

Denoting [symbol] as the part of the layer not in the lightcone at layer k, so that [symbol] , and noting the gates in [symbol] as [symbol] . Under the assumption that (in the Heisenberg picture) [symbol] can be propagated up to some time k+τⱼ, to obtain a unitary super-operator [symbol] (⋅)=Vⱼ·V^{†}ⱼ, and utilizing

$${ℬ}_{𝒿}^{*} = {B}_{j}^{*} \cdot {B}_{j}^{* †}$$

as the solution of the minimization problem

$${B}_{j}^{*} = {arg min}_{{B}_{j} = B ⊗ {I}_{\{ LC [ k + {τ}_{j} + 1 \} ]}} ‖ {V}_{j} - {B}_{j} ‖ .$$

where

$${ℬ}_{𝒿}^{*} ( \cdot )$$

acts outside the lightcone at layer k+τⱼ+1, and therefore commutes with [symbol] .

This provides

$$‖ {𝒰}_{1 : 𝓀 - 1} ( {𝒰}_{𝓀} - {\tilde{𝒰}}_{𝓀} ) {\tilde{𝒰}}_{𝓀 + 1 : ℒ} ( O ) ‖ = ‖ ( {𝒢}_{1 : 𝓂 - 1} {\tilde{𝒰}}_{𝓀 + 1 : 𝓀 + {τ}_{𝓂}} {𝒱}_{𝓂} - {\tilde{𝒰}}_{𝓀 + 1 : 𝓀 + {τ}_{𝓂}} ) {\tilde{𝒰}}_{𝓀 + {τ}_{𝓂} + 1 ℒ} ( O ) ‖ \\ using$$

$$( {𝒢}_{1 : 𝓂 - 1} {\tilde{𝒰}}_{𝓀 + 1 : 𝓀 + {τ}_{𝓂}} {ℬ}_{𝓂}^{*} {\tilde{𝒰}}_{𝓀 + {τ}_{𝓂} + 1 : ℒ} ) ( O ) = ( {𝒢}_{1 : 𝓂 - 1} {\tilde{𝒰}}_{𝓀 + 1 : ℒ} ) ( O ) , \\ indicating that$$

$$‖ {𝒰}_{1 : 𝓀 - 1} ( {𝒰}_{𝓀} - {\tilde{𝒰}}_{𝓀} ) {\tilde{𝒰}}_{𝓀 + 1 : ℒ} ( O ) ‖ \leq 2 ‖ {V}_{m} - {B}_{m}^{*} ‖ + ‖ ( {𝒢}_{1 : 𝓂 - 1} - I ) {\tilde{𝒰}}_{𝓀 + 1 : ℒ} ‖$$

While this analysis does not directly relate to the case where a gate [symbol] propagates to the end of the circuit, i.e. k+τₘ=L, however this relates to a different bound where

$$2 \vert {V}_{g} - {B}_{g}^{*} \vert$$

is replaced by |[V_{g}, O]|:

$$‖ ( {𝒢}_{1 : 𝓂 - 1} - I ) {\tilde{𝒰}}_{𝓀 + 1 : ℒ} ( O ) ‖ = ‖ {𝒢}_{1 : 𝓂 - 1} ( {\tilde{𝒰}}_{𝓀 + 1 : L} ) {𝒱}_{𝓂} - {\tilde{𝒰}}_{𝓀 + 1 : L} ( O ) ‖ \leq ‖ {𝒢}_{1 : 𝓂 - 1} ( {\tilde{𝒰}}_{𝓀 + 1 : L} ) ( {𝒱}_{𝓂} - I ) ( O ) ‖ + ‖ ( {𝒢}_{1 : 𝓂 - 1} - I ) ( O ) ‖ = ‖ [ {V}_{m} , O ] ‖ + ‖ ( {𝒢}_{1 : 𝓂 - 1} - I ) {\tilde{𝒰}}_{𝓀 + 1 : L} ( O ) ‖$$

The bound is denoted using η_{g}, such that

$${η}_{g} = \frac{1}{2} ‖ [ {V}_{g} , O ] ‖$$

is propagated until the end of the circuit, and

$${η}_{g} = ‖ {V}_{g} - {B}_{g}^{*} ‖$$

otherwise. By induction on m we obtain

$$‖ {𝒰}_{1 : 𝓀 - 1} ( {𝒰}_{𝓀} - {\tilde{𝒰}}_{𝓀} ) {\tilde{𝒰}}_{𝓀 + 1 : ℒ} ( O ) ‖ \leq 2 {\sum }_{j = 1}^{m} {η}_{j}$$

In this case, the gates that contribute to the sum are only the ones that intersect the lightcone. Accordingly, this provides

$$\vert 〈 {ρ}_{0} , ( {𝒰}_{1 : L} - {\tilde{𝒰}}_{1 : L} ) ( O ) 〉 \vert \leq 2 {\sum }_{g ∈ \partial L C} {η}_{g}$$

where the boundary ∂LC is the subset of gates in the circuit whose support includes qubits both inside and outside LC.

In the preceding analysis, omitting the initial state ρ₀, providing that the obtained bound holds for all initial states. This leads to a worst case bound over initial states. Alternatively, one can consider an average-case bound over initial states, in which case the operator norm is replaced by a normalized Frobenius norm. Indeed, considering n as the total number of qubits; b∈{0,1}ⁿ indicating a bit-string of length n; and ρ_{b}=|b [symbol] [symbol] b|, the corresponding computational basis state. For any operator A acting on the n qubits

$${2}^{- n} {\sum }_{b} \vert tr ( {ρ}_{b} A ) \vert = {2}^{- n} {\sum }_{b} \vert 〈 b \vert A \vert b 〉 \vert \leq {2}^{- n} {2}^{\frac{n}{2}} \sqrt{{\sum }_{b} {\vert 〈 b \vert A \vert b 〉 \vert}^{2}} \leq {2}^{\frac{n}{2}} {‖ A ‖}_{F} .$$

Providing the bound as:

$${2}^{- n} {\sum }_{b} \vert 〈 {ρ}_{b} , {𝒰}_{1 : L} ( O ) 〉 - 〈 {ρ}_{b} , {\tilde{𝒰}}_{1 : L} ( O ) 〉 \vert \leq {2}^{- \frac{n}{2}} {‖ ( {𝒰}_{1 : L} - {\tilde{𝒰}}_{1 : L} ) ( O ) ‖}_{F} .$$

One can continue as before to obtain

$${2}^{- \frac{n}{2}} {‖ ( {𝒱}_{m} - {ℬ}_{m}^{*} ) {\tilde{𝒰}}_{k + {τ}_{m} + 1 : L} ( O ) ‖}_{F} \leq 2 ( {2}^{- \frac{k}{2}} {‖ {V}_{m} - {B}_{m}^{*} ‖}_{F} )$$

where

$${V}_{m} - {B}_{m}^{*}$$

on the right hand side is considered an operator on k qubits.

As indicated above, the bound on bias can be determined as the sum of norms

$$‖ {V}_{g} - {B}_{g}^{*} ‖$$

and ∥[V_{g},]∥, which are computed for gates g∈∂LC.

Accordingly, some embodiments of the present disclosure provide a method for determining a bias (or a bound of the bias) based on data on a quantum circuit, an observable O, and a given or a selected lightcone LC. In some embodiments, the technique may determine or compute the norms for all gates g∈∂LC and provide a list of tuples of bound, gate, and/or layer index of the gate. In this connection, the method may operate to determine bounds of one or more gates by propagating a gate g forward across layers of the quantum circuit in a brute-force manner, such brute force propagation propagates the gate is as long as its support is less then a given maximal support (typically having an integer value). The maximal support value may provide a trade between classical complexity and the tightness of the bound. For higher maximal support, every g∈∂LC may be propagated further in time and possibly get a lower bias ng.

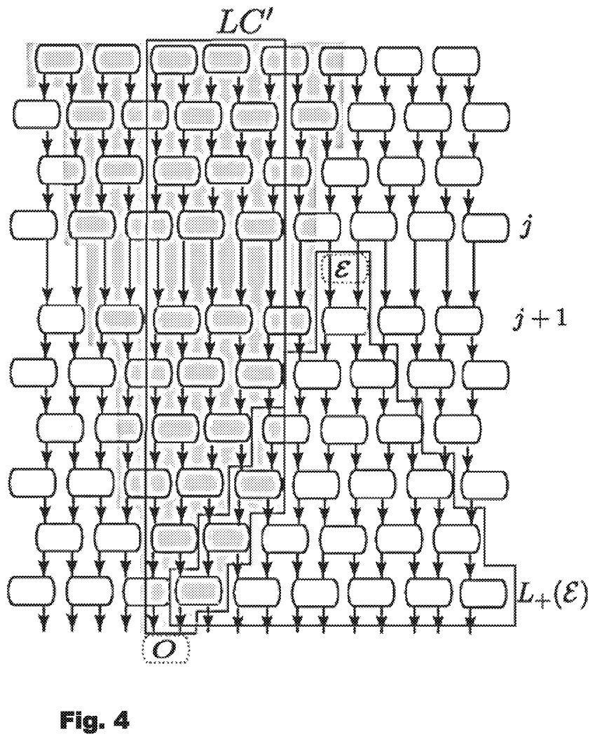

The notation ∥⋅∥. used above indicates that the operator norm or normalized Frobenius norm can be used. The support of the propagated gate, denoted herein by U, may generally increase rapidly as illustrated in FIG. 4 described in more detail further below. The gates that are not contained in the lightcone can be ignored during propagation, and inside the lightcone, the support can increase at most according to L₊(g).

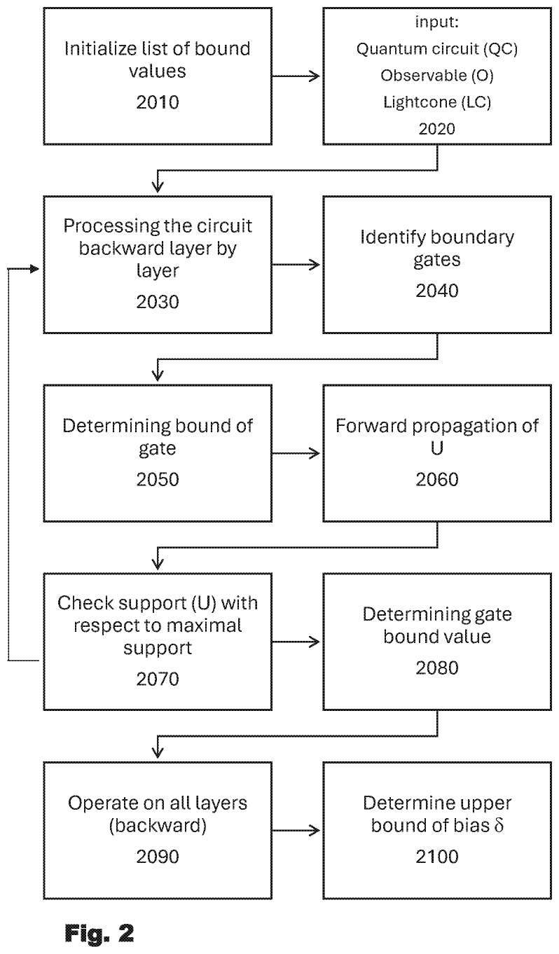

Accordingly, a Lightcone-Bounds method may be executed by one or more processors to determine bounds on a bias δ introduced when circuit operations are omitted or when noise channels are ignored outside a predefined expanding lightcone. The method is exemplified in FIG. 2 and may be applicable to objectives that include an expectation value of a target operator, such as an observable or a Hamiltonian term, and is particularly useful for selecting or validating a candidate lightcone for error mitigation and or reduced simulation, the method may utilize initializing of bound values (2010).

Further, the Lightcone-Bounds method receives input data (2020) including: a quantum circuit qc formed by L layers indexed by an integer layer index k∈{0, . . . , L−1}, where each layer includes one or more quantum gates; a target operator O, which defines an objective of interest, for example an expectation value [symbol] ; and a predefined expanding lightcone LC, represented, for example, by a per-layer qubit set LC[k] indicating which qubits are in the lightcone at layer k.

The method may further provide output including a set of per-gate bound results. In some embodiments, each per-gate bound result is a tuple (η_{g}, g, k), where: g identifies a boundary gate processed by the procedure; k is the layer index of the boundary gate; and η_{g} is a determined bound value (for example, a norm value) that upper bounds a bias δ contribution associated with gate g under the candidate lightcone.

to determine the output data, the method may operate for processing the circuit backward in a layer by layer manner (2030), identify boundary gates (2040), herein denoted ∂LC. Generally, a gate g in layer k is treated as a boundary gate when: the support of g (denoted supp(g), being the set of qubits acted on by g) intersects the lightcone at that layer or an adjacent layer, and the support of g is not fully contained in the lightcone at that layer, such that g acts on at least one qubit inside the lightcone and at least one qubit outside the lightcone.

Specifically, in some embodiments, the Lightcone-Bounds procedure iterates backward over layers, for example from layer L−1 down to layer 0. For each layer index k, the procedure determines a set of boundary gates g∈∂LC at layer k. For each identified boundary gate g, the procedure computes a per-gate bound value η_{g} by executing a gate-specific bound computation, described below, and stores an output tuple (η_{g}, g, k).

For each boundary gate g. The method utilizes the boundary gate g, its layer index k, the circuit qc, the target operator O, and the lightcone LC and operates to determine a bound of the gate (2050). To this end the method may process the circuit bounds by forward propagation of a propagated representation U (2060), e.g., using a unitary representation of the boundary gate g. In some embodiments, U may be initialized as the unitary action of g in an operator representation used for propagation (for example, a Heisenberg-picture propagation of an operator associated with g). The method may propagate U forward through layers following the layer k of g. In some embodiments, propagation proceeds for increasing layer indices j=k+1, k+2, . . . , L−1. For each layer j, one or more gates G present in layer j are examined, e.g. using a filtering rule to determine whether each gate G participates in the propagation update.

In some embodiments, an examined gate G is used to update U only if the gate G satisfies a containment condition and an intersection condition. The containment condition is satisfied if the support of gate G is fully contained in the lightcone at that layer, i.e., supp(G)⊆LC[j]; and the intersection condition is satisfied if the support of gate G intersects the current support of U, such that conjugation by G can change U.

When both conditions are met, U may be updated by conjugating U with G (or by an equivalent propagation update), thereby propagating the effect of the boundary gate g forward in time through gates that are within the lightcone and relevant to the current support.

As propagation proceeds, the support of U may be checked (2070) And optionally expanded. In some embodiments, the method monitors a support size of U, denoted |supp(U)|. If |supp(U)| exceeds the user-defined threshold maximal support (maxsupp), the propagation may be interrupted prior to reaching the end of the circuit. This interruption may provide a computationally controllable trade-off between classical cost and tightness of the resulting bound.

After propagation, the per-gate bound value η_{g} is determined (2080), this may utilizes one of two cases, depending if the propagation reaches the end of the circuit. If propagation continues through the final layer without violating the maximal support (maxsupp) constraint, the per-gate bound values η_{g} is determined as a norm of a commutator between the propagated representation U and the target operator O, where the commutator is [U, O]=UO−OU, and η_{g} is determined as η_{g}=∥[U, O]∥, where the norm may be a selectable norm such as an operator norm or a (normalized) Frobenius norm.

If propagation is interrupted, for example because |supp(U)| is higher than the maximal support (maxsupp), η_{g} may be determined using an extractability residual that measures how close U is to acting trivially on qubits inside the lightcone. In some embodiments, the subroutine determines an operator B* that minimizes a distance between U and an operator of the form I⊗B, where: I is an identity operator acting on qubits inside the lightcone (or inside a selected in-cone subsystem), and B is an operator acting on qubits outside the lightcone (or outside the selected in-cone subsystem). Accordingly, in some embodiments, η_{g} may be determined by: η_{g}=min_{B}∥U−I⊗B∥=∥U−I⊗B*∥, where the norm is a selectable norm.

The bound of the gates is determined for all layers backward (2090) to determine an upper bound of the bias δ (2100) and returning and aggregating results. Generally, the method may η_{g} to the Lightcone-Bounds procedure, which stores the output tuple (η_{g}, g,k). The resulting list of per-gate bound values can be used to form a total bias bound for the candidate lightcone. For example, in some embodiments, the total bias bound may be obtained by summing per-gate bound values over boundary gates, optionally with weights based on gate type, layer, or objective structure. In some embodiments, the list of ng values may further be used to rank gates, identify dominant bias contributors, or compare candidate lightcones under a user-selected bias budget.

In some cases, a given expanding lightcone LC may be predetermined and/or given including determining bounds η_{g} for all 2-qubit gates g in ∂LC. Such given lightcone data can also be used to bound the effect of any unitary error ε acting outside the lightcone. Assuming ε acts just after a selected layer j and that the circuit from that point onward is ideal, while the circuit up to layer j need not be ideal.

In this connection, some embodiments of the present disclosure may utilize forward connectivity lightcone to refine the bias δ bound for selected errors. This method is based on a forward connectivity lightcone L₊(ε) associated with an error ε. The bias δ due to the error ε depends only on the gates along the lightcone L₊(ε), as all other gates can be “pulled back” to C. This metho assumes that support(O) has intersection with the support of L₊(ε) at the last layer, since otherwise the bias is obviously 0.

Considering the reduced circuit

$${𝒰}_{j + 1 : L}^{′} = {𝒰}_{j + 1}^{′} … {𝒰}_{L}^{′}$$

from layer j+1 forward containing only the gates in L₊(ε). And considering a lightcone LC′ for this circuit that is the intersection of the original one, LC, with L₊(ε), such that if a qubit q at a layer/is outside L₊(ε), then q∈LC′[l] if q∈LC′[l+1]∩LC[l+1]. In other words, LC′ is LC∩L₊(ε) and its “shadow” on first layer.

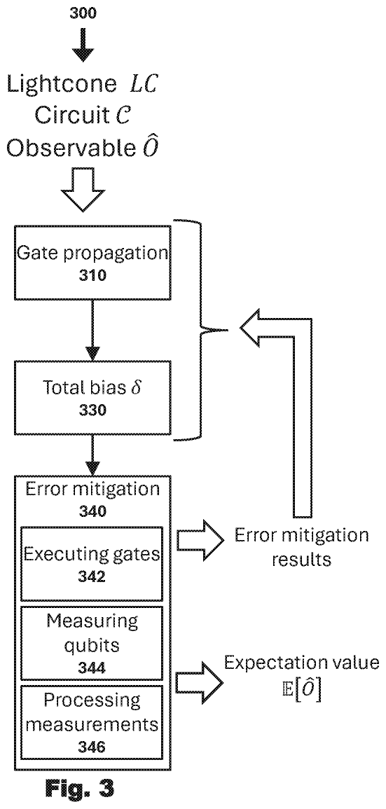

FIG. 3 shows a flowchart schematically illustrating a broad aspect of a method 300 according to the present disclosure. The method 300 may receive as an input a lightcone LC, a quantum circuit [symbol] , and an observable Ô. The quantum circuit [symbol] may include a plurality of gate layers.

The method 300 may include computing a gate propagation (210) as described hereinabove, for at least one quantum gate included in the quantum circuit [symbol] . The gate propagation may be a forward propagation, and/or backwards propagation. In some embodiments, every gate propagation may be a forward propagation. In other words, for every quantum gate (included in the quantum circuit [symbol] ) for which a gate propagation is computed, the gate propagation may be a forward propagation. In some other embodiments, every gate propagation may be a backward propagation. In other words, for every quantum gate (included in the quantum circuit [symbol] ) for which a gate propagation is computed, the gate propagation may be a backward propagation.

Computing a gate propagation, for every quantum gate for which a gate propagation is computed, results in a propagated gate U, according to which further computations may be performed. Generally, for every quantum gate gᵢ for which a gate propagation is determined, an associated propagated gate Uᵢ is obtained.

The method further includes, determining a total bias δ associated with the lightcone LC (330). The total bias quantifies a magnitude of errors in measuring the observable O, where only the gates included in the light cone LC are preferably executed (and qubits associated with the observable Ô are measured). The total bias δ can be computed according to the propagated gate U. In some embodiments, for each propagated gate Uᵢ, an associated bias contribution term η_{g}_{ᵢ} is determined. The total bias δ can be determined as a function of the bias contribution terms η_{g}_{ᵢ}. Generally, the total bias δ may be determined as a linear function of the bias contribution terms η_{g}_{ᵢ} (i.e., being a direct or a weighted sum). While in some embodiments, the total bias δ may be determined by a non-linear function of the bias contribution terms η_{g}_{ᵢ}.

In some embodiments, the target of method 300 may providing the total bias δ, and thus the method 300 may terminate by providing output data including the total bias δ. further, in some other embodiments, the method 300 may include error mitigation (340) through the quantum circuit (QC). such error mitigation may utilize the total bias δ may be used for selection of a lightcone indicating the specific gates that are mitigated, to provide reliable observable output. For example, a plurality of different lightcones may be determined for a given observable within a given quantum circuit, where each lightcone may be associated with a respective total bias δ. Selection of a proper lightcone may be based on the lightcone LC that is associated with optimal, e.g., minimal total bias δ, or having a total bias δ lower than a predefined or a selected threshold.

Following selection of a proper lightcone based on the total bias δ thereof, error mitigation process operates to execute gates included in the selected lightcones (342) and apply measurement to observable qubits (344). differently from the process of determining a lightcone, error mitigation may typically execute the gates in forward propagation from initial layer to observable layer. While in some embodiments, at least one gate included in the lightcone LC is executed according to an error mitigation protocol. Typically a plurality of gates, and preferably all gates that are completely included within the lightcone, are executes. further, the execution of the gates may be utilize implementation of a selected quasi-probability protocol.

Measurement of qubits that are associated with the observable Ô (344) typically provides output including measurement results. In some embodiments, the method may further include processing the measurement results (346) to provide an estimation of an estimation of an expectation value of the observable [symbol] [Ô]. In this connection, a naïve process of determining the expectation value of the observable may often involve various errors associated with various influences on the quantum circuit. The method may accordingly utilize on or more error mitigation processes for processing the expectation values. As indicated above, the error mitigation processes may be applied on gates within the selected lightcone, to minimal bias as described herein, while processing the measurement results may incorporate error mitigation processes to provide results with increased accuracy and reliability. Error mitigation results may include any information on the expectation value of the observable [symbol] [Ô]. For example, error mitigation results may include one or more moments of the distribution of the measurement results of the observable, such as a variance of the observable [symbol] [Ô], functional dependence of the expectation value of the observable [symbol] [Ô] on one or more selected parameters of a quasi-probability protocol associated with at least one gate included in the lightcone LC, or other selected data relating to the expectation values of the observable.

In some embodiments, where the method 300 includes performing error mitigation (340), such error mitigation may precede other steps of the method. In other words, the method may perform error mitigation to obtain the error mitigation results, and use the so-obtained results as input to perform computation of gate propagation (310). further, in some embodiments, error mitigation results may also be used as input for determining the total bias δ (330).

Further FIG. 4 illustrates a layered quantum circuit and multiple regions used to analyze how an out-of-lightcone unitary disturbance affects a selected objective. A first region corresponds to a candidate lightcone (shown as a shaded gray region), which represents circuit positions whose operations are treated as potentially influencing the objective. FIG. 4 further shows a second region denoted LC′, which is a reduced lightcone derived from the candidate lightcone by restricting attention to circuit positions that are relevant to propagation of a selected disturbance using the method described herein with respect to boundary gates.

Additionally, FIG. 4, illustrates a polygonal region denoted L₊(ε) schematically represents the forward connectivity lightcone of a selected unitary error ε (or, in some embodiments, a selected gate location associated with that error). The region L₊(ε) bounds which later circuit positions can be reached as the effect of error ε is propagated forward through subsequent layers via multi-qubit interactions. Lightcone LC′ is defined using L₊(ε) to remove portions of the candidate lightcone that cannot be influenced by error ε. In some embodiments, LC′ is formed as a layer-wise intersection between the candidate lightcone and L₊(ε), optionally together with a layer-consistency rule that preserves membership for certain qubits outside L₊(ε) when needed to maintain a valid per-layer representation across adjacent layers.

As a result, FIG. 4 illustrates that bounding the contribution of an error ε may be determined using LC′ rather than the full candidate lightcone, which can reduce the number of circuit positions considered while preserving correctness of the resulting bias bound. Stated differently, LC′ keeps the portion of the candidate lightcone that lies within the region that can actually be reached by forward propagation from ε, and discards portions that are outside L₊(ε) and therefore irrelevant to the effect of ε on the objective.

Additionally, In some embodiments, the present disclosure provides for evaluating bias introduced by noise channels located outside an expanding lightcone. A noisy circuit may be modeled as an ideal layerwise unitary computation with an after layer noise channel applied after one or more layers of the quantum circuit, such that the noisy circuit is:

$${Λ}_{L} {𝒰}_{L}^{†} … {Λ}_{2} {𝒰}_{2}^{†} {Λ}_{1} {𝒰}_{1}^{†} .$$

In some exemplary models, the noisy computation may be expressed as a sequence of ideal layers with corresponding noise superoperators, where each layer noise superoperator Λₗ may be decomposed into one or more component channels Λ_{l,j}, and where the component channels may be ordered (that is, the order of Λ_{l,j} may matter). Each component channel Λ_{l,j} may be expressed as a probabilistic mixture of a do-nothing component and one or more unitary error operators

$${ℰ}_{k}^{( l , j )}$$

occurring with probabilities

$${p}_{k}^{( l , j )} ,$$

so that Λ_{l,j} is representable as an identity contribution plus a weighted sum of unitary errors, such as:

$${Λ}_{l , 1} = ( 1 - {\sum }_{k} {p}_{k}^{( l , j )} ) 𝒥 + {\sum }_{k} {p}_{k}^{( l , j )} {ℰ}_{k}^{( l , j )} .$$

This model is broad enough to represent, for example, crosstalk terms, idle errors, insertion of a single unitary error, and removal of gates as a special case.

In some embodiments, the disclosure defines per-location and aggregate noise measures. For example, using an infidelity value

$${IF}_{LC}^{( l , j )}$$

derived from the error probabilities at location (l, j) by

$$I {F}_{L C}^{( l , j )} = {\sum }_{k : {ℰ}_{k}^{( l , j )} in LC} {p}_{k}^{( l , j )}$$

This may also utilize an average infidelity across the circuit. Accordingly, given a lightcone LC, an LC-restricted infidelity term may also be defined that sums only those error probabilities whose corresponding errors have support in the lightcone.

In addition to a binary lightcone that specifies circuit locations, some embodiments support a non-binary lightcone that specifies a transformation of the noise model by applying per-error scaling factors

$${x}_{k}^{( l , j )}$$

to the probabilities

$${p}_{k}^{( l , j )}$$

$$( for example , {p}_{k}^{( l , j )} ↦ {x}_{k}^{( l , j )} {p}_{k}^{( l , j )} ) ,$$

thereby representing selective amplification, attenuation, or effective removal of noise terms.

Under this noise model as indicated above, some embodiments of the present disclosure provide an analytic bound on bias when errors occur only outside an expanding lightcone. In some examples, if the support of each unitary error

$${ℰ}_{k}^{( l , j )}$$

is disjoint from the lightcone at the corresponding layer, the absolute bias in the objective (for example, an expectation value of an operator O) is determined to be upper bounded by a sum of contributions over error locations and error components. Each contribution may scale with the corresponding probability p and a norm of an operator expression of the form (ε− [symbol] ) applied to the objective propagated through the suffix of the circuit, thereby yielding a computable bias bound that depends on the selected lightcone and the circuit suffix dynamics.

In a further corollary, some embodiments note that for an exact lightcone, any set of error channels outside that exact lightcone yields zero bias for the objective.

The bias bound may also be determined using a tensor network contraction. More specifically, in some embodiments of the present disclosure, a tighter bound can be determined using classical computing using tensor network contraction techniques. The bias may be written in a form that depends on a composite superoperator M^{†} derived from combining the ideal evolution with the noisy evolution (noting that M^{†}=U^{†}N^{†}), and then bounded by a norm of ∥( [symbol] −M^{†})(O)∥, i.e. acting on the objective operator (O). In some embodiments, an operator norm may be used, and in other embodiments the operator norm may be replaced by a normalized Frobenius norm to obtain a bound, requiring lower computational resources, or better reflecting typical-case behavior.

This tensor-network based approach aligns with techniques described as tensor error mitigation (TEM), which assume that the composite operator M^{†} can be represented efficiently as a tensor network and contracted from the middle outward. In one-dimensional circuits, M^{†} may naturally be represented as a matrix product state (MPS), and for other geometries other tensor network structures (for example, Projected Entangled Pair States (PEPS)) may be used. The contraction difficulty generally increases as noise strength increases (that is, as the noise channels deviate further from identity). Unlike the analytic bound above, the TN contraction approach may only assume that the noise channels are close to identity, while otherwise permitting arbitrary channel structure, and it can also incorporate a non-binary lightcone representation of the noise model.

Further, in the QP context, some embodiments describe that errors inside a selected lightcone are mitigated in post-processing while errors outside the lightcone are effectively amplified, and conjecture that if TEM contraction is feasible for the physical noise model then contraction may remain feasible for QP with a reasonable lightcone selection.

Additionally, in some embodiments of the present disclosure, the analytic bounds naturally motivate an algorithm for finding an expanding lightcone. Such expanding lightcone is referred to as a Commutativity-LC, and may be determined by a commutativity lightcone procedure. The procedure selects a threshold ϵ>0 and operates to determine a lightcone such that bound terms associated with boundary interactions are each at most ϵ, thereby targeting a reduced lightcone volume subject to a user-selected bias budget. The lightcone may be represented as a list S of per-layer qubit supports of length L+1, where the final entry is initialized as S[L]=support(O). The method further processes the quantum circuit by layers from last to first to determined gates to be included in the lightcone. At a given layer l, the method identifies gates that intersect the lightcone but are not contained in the support for the added layer S[l+1]. The method further determine for the identified gates if they can be gate can be approximately extracted from the lightcone in attempt to push the gate forward through later in-cone gates. Depending on whether the gate can be propagated to the end of the circuit, the gate is considered as approximately extractable based on a test evaluating either (i) an extractability residual based on approximating the propagated representation by an operator of the form I⊗B, or (ii) an approximate commutation test with O at the end of the circuit. If the gate is not approximately extractable under ϵ, the lightcone is expanded by adding at least one qubit acted on by the gate.

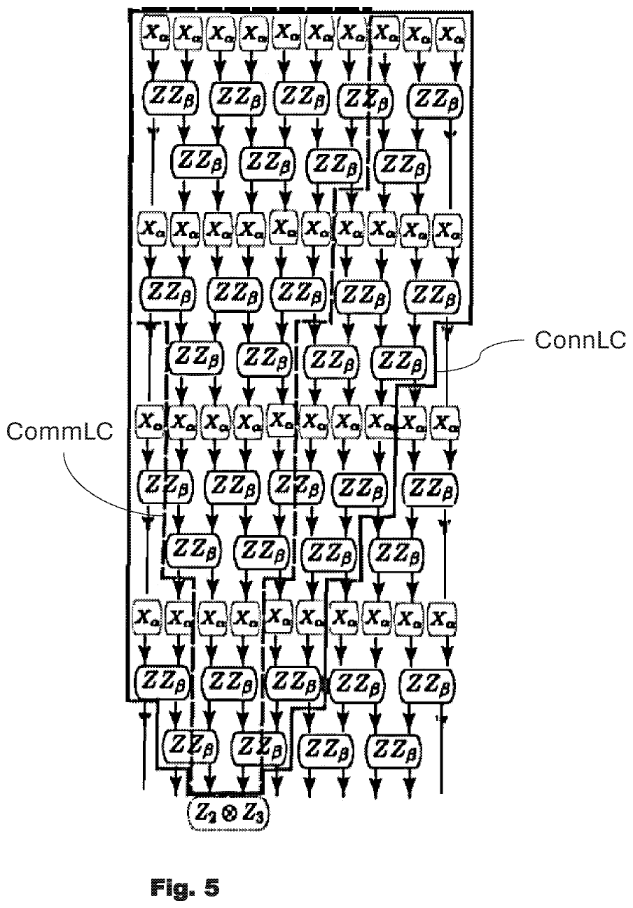

In some embodiments, the special case ϵ=0 yields an exact expanding lightcone, meaning that gates outside the resulting lightcone can be removed without changing the objective in the ideal circuit (and, correspondingly, errors outside that lightcone do not contribute bias). FIG. 5 illustrates an exemplary circuit in which a connectivity lightcone and a commutativity-based lightcone differ substantially in size. In the illustrated example, a solid line delineates the connectivity lightcone (ConnLC) of the objective, and a dashed line delineates the output of the commutativity lightcone (CommLC) method for a selected threshold (for example, ϵ=0 in the illustrated example). The dashed lightcone (CommLC) is shown as strictly smaller than the solid ConnLC boundary in at least a portion of the circuit depth, illustrating that ConnLC may be conservative and that commutativity or extractability based construction can reduce the included circuit volume while preserving the desired bias property for the objective, and potentially simplifying error mitigation and/or classical simulation of the quantum circuit given the desired observable.

Accordingly, as indicated above, a plurality of candidate lightcones may be associated with a given objective (for example, an observable operator O) for a selected quantum circuit, where the different lightcones may differ in lightcone volume and in an associated bias budget δ, and where each candidate lightcone may be evaluated using per gate or per layer bound values (for example, η_{g} values) that are aggregated to obtain a total bias estimate or bias bound for that candidate lightcone. Accordingly, some embodiments of the present disclosure relate to a method for identifying an optimal lightcone, enabling simplification of quantum simulation and/or error mitigation with reduce or controlled biad. Such optimal lightcone may also be used for post-processing of measurements of Quasi Probability (QP) Error mitigation.

Generally, each lightcone defines a distinct QP estimator from utilizing common experimental data, which has an associated bias and variance. Determining an optimal lightcone may aim to minimize some metric which is the function of the two. For example, an exact lightcone, like ConnLC or the output of the commutativity lightcone method described above for ϵ=0 may has zero bias, but may also have a variance which can be much higher than desired. The data from a QP experiment can contain valuable information useable to estimate a bound for the bias due to mitigation only inside a candidate lightcone.

Considering a quantum circuit C and a local observable O, for which the target is to estimate the expectation value [symbol] using a QP experiment. Let O_{id} and Oₙ denote the ideal and noisy expectation values of O, respectively. Further, supposing N_{c} circuits being sampled according to the QP distribution, constructed to cancel all of the noise in the circuit, and where each of the circuits is repeated for a selected number Nₛ of shots, allowing to average the expectation value. Each of the number of shots is considered to relate to a respective circuit C₁, . . . , C_{N}_{_{c}}, where O; is the mean over the Nₛ shots of Cᵢ circuit. For simplicity, the following assumes an error model as described above, where each error channel Λ_{l,j} acts on 1 or 2 qubits. Given a candidate lightcone LC_{cand}, post-processing can provide error mitigation only for error channels with a support that intersects LC_{cand} [l+1] (for all l), at a price of introducing an estimation bias.

By mapping a samples circuit Cᵢ to its associated sign, σ^{cand} (Cᵢ)=±1. A function w^{cand} may mapping the circuit from the noise layers to the QP norm, associated to $LC_{cand}.

$${w}^{c a n d} ( {Λ}_{l} ) = {\prod }_{1 \leq j \leq {m}_{l} : support ( {Λ}_{l j} ) ∩ LC [ l + 1 ] \neq ∅} w ( {Λ}_{l , j} )$$

where w maps a channel to its corresponding QP norm, that is, if the error channel Λ is inverted with the QP distribution $Λ⁻¹= [symbol] , then $w(Λ)=Σᵢ|pᵢ|. The total QP norm associated with LC_{cand} is

$${W}_{c a n d} = {\prod }_{l = 1}^{L} {w}^{c a n d} ( {Λ}_{l} ) .$$

Generally the QP norm is exponential in the lightcone volume, specifically

$${W}_{c a n d} \geq {\prod }_{l , j} ( 1 + 2 I {F}_{L {C}_{c a n d}}^{( l , j )} ) \approx {e}^{( 2 I F \vert {LC}_{c a n d} \vert )}$$

where IF and

$$I {F}_{L {C}_{c a n d}}^{( l , j )}$$

are defined above, with respect to noise outside the lightcone.

Accordingly, the present technique provides the QP estimator associated with LC_{cand} as

$${\hat{O}}_{c a n d} = \frac{{W}_{c a n d}}{{N}_{c}} {\sum }_{i = 1}^{{N}_{c}} {σ}^{c a n d} ( {C}_{i} ) {O}_{i} .$$

In some examples, reducing the variance of the QP estimator is associated with reduced norm of the QP. This is associated with determining the variance of the estimator for an exact lightcone and a candidate lightcone as

$$𝕍 {\hat{O}}_{e x} = {N}_{c}^{- 1} {W}_{e x}^{2} [ 𝔼 {〈 O 〉}_{c}^{2} ] - {O}_{i d}^{2} {W}_{e x}^{- 2} + {N}_{s}^{- 1} {V}_{s} ]$$

$$and$$

$$𝕍 {\hat{O}}_{c a n d} = {N}_{c}^{- 1} {W}_{c a n d}^{2} [ 𝔼 [ {〈 O 〉}_{c}^{2} ] - {( 𝔼 {\hat{O}}_{c a n d} )}^{2} {W}_{c a n d}^{- 2} + {N}_{s}^{- 1} {V}_{s} ]$$

where

$${V}_{s} = 𝔼 [ {〈 {O}^{2} 〉}_{c} ] - 𝔼 [ {〈 O 〉}_{c}^{2} ] ,$$

[symbol]

denotes the noisy expectation value of O for circuit c, and c runs over all circuits in the QP distribution of the ideal circuit. This imply that

$$\frac{𝕍 {\hat{O}}_{cand}}{𝕍 {\hat{O}}_{e x}} \leq {( \frac{{W}_{cand}}{{W}_{e x}} )}^{2} \frac{𝔼 [ {〈 O 〉}_{c}^{2} ] + {V}_{s} {N}_{s}^{− 1}}{𝔼 [ {〈 O 〉}_{c}^{2} ] − {O}_{i d}^{2} {W}_{e x}^{− 2}}$$

The multiplying factor

$${( \frac{{W}_{c a n d}}{{W}_{e x}} )}^{2}$$

does not depend on LC_{cand}. Moreover, in QP error mitigation

$$𝔼 [ {〈 O 〉}_{c}^{2} ]$$

is typically larger (or much larger) than

$${O}_{i d}^{2} {W}_{e x}^{- 2} and {V}_{s} {N}_{s}^{- 1} ,$$

so it can be estimated that

$$\frac{𝕍 {\hat{O}}_{cand}}{𝕍 {\hat{O}}_{ex}}$$

is smaller, or approximately equal to

$${( \frac{{W}_{c a n d}}{{W}_{e x}} )}^{2} ,$$

which indicate that reducing the volume of the lightcone reduces the variance over that of LCₑₓ. Further, it can be estimated that

$$\frac{{W}_{c a n d}}{{W}_{e x}} ∼ exp ( 2 IF ( \vert {LC}_{c a n d} \vert - \vert {LC}_{e x} \vert ) .$$

However, using a lightcone smaller then an exact lightcone may generally introduce a bias, estimated by B_{cand}= [symbol] Ô_{cand}−O_{id}. For any exact candidate lightcone, the estimator is generally unbiased. In particular, an exact lightcone determined regarding a quantum circuit with ϵ=0 as indicated above may be used, providing unbiased estimator. This may provide an improved estimator over that obtained from ConnLC, however the obtained lightcone is typically too large, in the sense that a smaller lightcone can be used while introducing only a small amount of bias, or an acceptable bias, and simplifying processing. Ideally, a small amount of bias means that B_{cand}<<

[symbol]

More generally, such candidate lightcone may balance bias and variance based on several metrics including: fixing some τ>0 and find a lightcone that minimizes [symbol] Ô_{cand} subject to |B_{cand}|<< [symbol] ; and/or considering the mean squared error (MSE) associated to LC_{cand} and LCₑₓ as

$$M S {E}_{c a n d} = 𝔼 [ {( {\hat{O}}_{c a n d} - {\hat{O}}_{i d} )}^{2} ] = 𝕍 {\hat{O}}_{c a n d} + {B}_{c a n d}^{2} ,$$

and MSEₑₓ= [symbol] Ôₑₓ, and find a lightcone that minimizes MSE_{cand}.

A naive approach to bounding the bias B_{cand} based on experimental QP data, may include checking for consistency of the (dependent) estimators Ôₑₓ and Ô_{cand}. In particular, a consistency parameter t may be defined as

$$t = \frac{\vert {\hat{O}}_{e x} - {\hat{O}}_{c a n d} \vert}{\sqrt{𝕍 [ {\hat{O}}_{e x} - {\hat{O}}_{c a n d} ]}}$$

For example, maintaining simplicity and consistency, the consistency parameter t may be declared as being greater than one, t>1 implying a statistically significant bias in Ô_{cand}. However, due to the large variance of Ôₑₓ, even if Ô_{cand} has a large bias, e.g, B_{cand}= [symbol] , for k>1, the probability to measure consistency is not small. This indicates that while a naïvely determined lightcone may provide small bias, it may be associated with high variance. Accordingly, the present disclosure utilizes an estimated candidate lightcone, possibly having increased bias, while having reduce lightcone volume (lower number of gates within the lightcone) thereby reducing variance and simplifying processing.

Accordingly, in some embodiments, a quasi-probability (QP) error mitigation experiment is performed once for a selected quantum circuit and objective, and the resulting dataset may then be reused to evaluate a plurality of candidate lightcones in post-processing. In this setting, each candidate lightcone may define a corresponding estimator for the objective. Generally, reducing the lightcone volume reduces the QP sampling overhead and therefore reduces estimator variance, while also introducing mitigation bias because noise channels outside the candidate lightcone are not fully canceled and, in QP post-processing, may be effectively amplified. Accordingly, some embodiments of the present disclosure provide utilize a technique that selects a candidate lightcone that is likely to reduce variance more than it increases bias, thereby improving an overall accuracy metric such as mean-squared error (MSE). such technique may be used in post processing, pre-processing or quantum simulation of a circuit.

In some embodiments, the method operates to identify a difference region between an exact or reference lightcone and a candidate lightcone, the difference region including circuit positions that are inside the reference lightcone and outside the candidate lightcone. The technique then estimates a quantitative bias contribution associated with that difference region using a common QP dataset. In some examples, the QP dataset includes, for each shot, (i) an indication of which QP-modified circuit instance was executed and (ii) a corresponding measurement outcome. In some embodiments, the method may filter or partition between shots of the quantum circuit according to whether QP modifications occurred within the candidate lightcone and whether QP modifications occurred within the difference region. Using one or more such filtered subsets, the technique estimates a decay factor or attenuation parameter associated with noise in the difference region, and uses the estimated parameter to determine a candidate bias estimate \hat{B}_{cand} or a candidate bias bound for the candidate lightcone.

In some embodiments, the candidate bias estimate \hat{B}_{cand} may be combined with an empirical or analytic variance estimate for the candidate estimator, thereby providing a quantitative basis for accepting or rejecting a candidate lightcone. For example, the technique may operate to determine an estimated or upper-bounded mean-squared error

$$M S {E}_{c a n d} \approx Var ( {\hat{O}}_{c a n d} ) + {\hat{B}}_{c a n d}^{2} ,$$

and to compare it to a corresponding value for a reference estimator. In some other examples, the technique may evaluate a bias-to-uncertainty ratio, such as |B_{cand}|≤\sqrt{τVar(Ô_{cand})} for a selected threshold τ, and selects the smallest-volume candidate lightcone that satisfies this inequality. In still some another examples, the technique may operate to determine a confidence-adjusted improvement metric (for example, an upper confidence bound on MSE_{cand}/MSE_{ref}) and to select a candidate lightcone only when the confidence-adjusted metric indicates improvement over the reference lightcone. In this manner, the selection is supported by quantitative estimates derived from the QP dataset, rather than by qualitative agreement tests between noisy estimators, and provides a practical mechanism for trading off variance reduction against bias increase when choosing a lightcone for post-processing.

The bias estimation technique described above may be further generalized beyond special cases in which the effect of noise inside a candidate lightcone and the effect of noise outside the candidate lightcone are treated as separable. In such embodiments, the method may operate to model the objective value as depending on a first set of parameters associated with noise inside the candidate lightcone and a second set of parameters associated with noise outside the candidate lightcone. For example, the objective may be expressed as O(λ, μ)=O_{id}F(λ, μ), where O_{id} indicates the ideal objective value, λ parameterizes noise processes within the candidate lightcone, μ parameterizes noise processes outside the candidate lightcone, and F(λ, μ) characterizes the deviation from the ideal value with F(0,0)=1. In some embodiments, a first-order approximation may be applied with respect to the outside-noise parameters μ, yielding an approximation in which the candidate bias is determined by a sensitivity of the circuit to outside-lightcone noise, optionally conditioned on the level of inside-lightcone noise.

This generalized technique may use the QP dataset to estimate objective values corresponding to multiple effective noise settings, rather than relying on a single estimate of the noise. In one example, QP injection is treated as producing an effective scaling of at least some noise parameters, such that subsets of the collected QP data can be used to estimate objective values corresponding to approximately scaled parameter pairs (λ, μ), (λ, 2μ), (2λ, μ), and (2λ, 2μ). These estimates are then combined, for example by forming ratios between estimates with and without the outside-noise scaling, to obtain an estimation of an outside-noise contribution term. In some embodiments, two such outside-noise contribution estimations may be determined at different effective inside-noise settings (for example, at λ and at 2λ), and an extrapolation is performed to infer a contribution corresponding to a low-inside-noise limit (for example, an estimate of an outside-noise sensitivity term evaluated at λ≈0). This inferred contribution can then be used to determine (e.g. compute) a candidate bias estimation \hat{B}_{cand} for the candidate lightcone.

In this manner, some embodiments of the present disclosure provide a quantitative basis for selecting a lightcone within a set of candidate lightcones, while inside-lightcone and outside-lightcone noise effects are coupled. This can be done by reusing a single QP dataset to estimate bias contributions under multiple effective noise scalings. The resulting candidate bias estimate \hat{B}_{cand} may then be combined with a variance estimate for the candidate estimator, as described above, to select a candidate lightcone that is expected to reduce variance more than it increases bias, for example by minimizing an estimated or upper-bounded mean squared error or by satisfying a confidence-adjusted bias-to-uncertainty criterion.

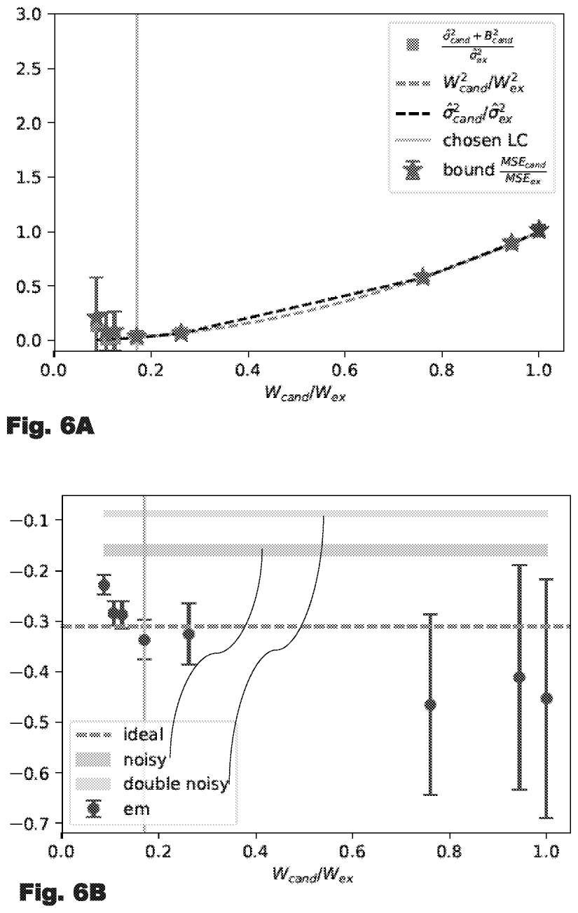

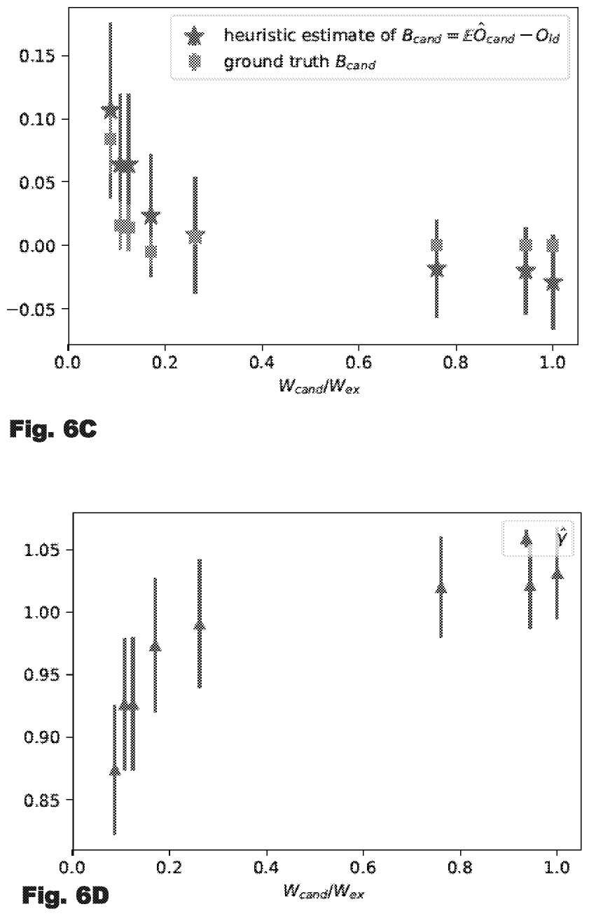

In this connection, reference is made to FIGS. 6A to 6D, and to FIG. 7 showing exemplary simulation results. FIGS. 6A to 6D illustrate an example application of the above described method for selection of nested lightcones to a kicked Ising Trotter circuit on a 4×5 grid, for an objective observable Ô=Z₃⊗Z₄. Candidate lightcones are generated for different threshold values ϵ>0, while a reference lightcone LCₑₓ corresponds to ϵ=0.

FIG. 6A plots the reduction in quasi probability overhead as a function of candidate selection, showing that W_{cand}/Wₑₓ tracks the corresponding reduction in estimator variance

$$( for example , {σ}_{c a n d}^{2} / {σ}_{e x}^{2} , or ) .$$

The vertical axis relates to a ratio to the exact-cone baseline including the MSE ratio.

In FIG. 6A, candidate evaluation results are marked as valid or invalid according to the selection criterion, and a vertical indicator marks the chosen candidate lightcone selected as optimal under the section's decision rule. FIG. 6B shows the resulting mitigated estimate Ô_{cand} with a statistical error bar (em), and illustrates that an appropriately chosen candidate can materially reduce the error bar relative to larger candidates and relative to LCₑₓ, while smaller candidates may begin to introduce a statistically significant bias.

FIG. 6C and FIG. 6D illustrate the quantitative basis for the selection decision. FIG. 6C compares a data-driven bias estimate for B_{cand} to a ground-truth bias value computed using trajectory sampling and statevector simulation, showing close agreement in the illustrated example. FIG. 6D shows an estimated parameter (denoted γ) used by the heuristic bias estimation procedure and or its associated bound calculation, thereby supporting acceptance or rejection of candidates using a quantitative bias-variance tradeoff rather than a simple consistency check between noisy estimators.

FIG. 7 shows aggregated simulation results across multiple Trotter circuits and observables, showing performance of method for selection between nested lightcones at scale. Each in the graph point corresponds to an observable within a circuit, and the plotted quantities relate to a ground-truth mean-squared-error (MSE) associated with the lightcone choice selected by the algorithm (X-axis) and a decay constant Λ=log(O_{id}/Oₙ) (Y-axis). Points for which A is undefined or negative are placed on a reference dashed line at Λ=−0.5.

FIG. 7 also exemplifies and summarizes empirical outcomes of the selection approach: across the simulated set, the algorithm reduces MSE relative to the reference exact-lightcone estimator MSEₑₓ for a majority of observables, and for a substantial fraction of cases yields large improvements (including reductions by at least an order of magnitude).

The object of determining whether a candidate lightcone can be reduced may include propagating a representation associated with a boundary operation (for example, a boundary gate g) forward through later circuit layers and computing a quantity indicative of its influence on an objective operator O. As described above, a brute-force propagation may repeatedly update a propagated unitary U by conjugation with later in-cone gates, for example U←GUG^{†}, and then compute either a commutator-based bound ∥[U, O]∥ if propagation reaches the end of the circuit, or an “extractability” residual ∥U−I⊗B*∥ if propagation is stopped early.

In some embodiments, this brute-force propagation may become classically expensive because the support of U can expand quickly as it intersects multi-qubit gates (even when gates outside the lightcone are ignored). To address this, some embodiments of the present disclosure utilize a randomized propagation procedure that estimates the same type of influence information while controlling support growth. The randomized propagation may be used, for example, to (i) estimate or bound per-gate contributions used in a Lightcone-Bounds style aggregation, (ii) implement or accelerate an approximate-extractability test used in a commutativity or extractability lightcone construction, and or (iii) rank candidate boundary gates by estimated influence without explicitly constructing large-support operators.

The randomized propagation may be framed in terms of moving an operator that represents an objective, an intermediate observable, or an error term through the circuit while probabilistically compressing it back onto a smaller subsystem.

As an illustrative case, consider a two-qubit gate b and an operator a supported on a strict subset of the qubits acted on by b. Conjugation by b generally expands a onto a larger support, yielding

$${a}^{′} = {b}^{- 1} a b ,$$

which can be expanded in an operator basis (for example, a Pauli basis) as a sum over tensor-product components. Rather than storing the full expansion, some embodiments may determine or compute one or more reduced operators by partially tracing out a subset of qubits, and then define a scalar “quality” or “information” measure for the reduced operator. The reduced operator is then used as the next operator to propagate, thereby keeping the propagated representation supported on a limited number of qubits at each step.

This compression may be characterized using a grade value. For example, after producing a reduced operator M′ (e.g., by partial trace and renormalization), a grade g may be determined by:

$$g = d T r ( {M}^{′2} )$$

where d is the Hilbert-space dimension associated with the subsystem of interest. The grade g lies in [0, 1] under consistent normalization. A grade of g=1 indicates that M′ is proportional to an identity operator on the subsystem (so that measuring it contains no information about earlier gates), while a grade near 0 indicates strong dependence on earlier circuit operations.

In some embodiments, the grade is used to decide whether a candidate gate location is outside an “effective” lightcone under a tolerance ϵ. In some examples, the method may utilize decision logic including:
1. Initialization with an operator M associated with the objective to be estimated.
2. Applying the basic randomized propagation/compression action across one or more circuit gates to obtain a reduced operator M′ and compute its grade g.
3. Repeating the randomized step multiple times to obtain grades g₁, g₂, . . . , gₙ, and compute an empirical average grade g.
4. Determining a tested gate (or gate location) as being outside the effective lightcone if g̅>1−ϵ with high confidence; or treating the gate as inside the effective lightcone and proceeding to earlier gates.

This technique supports a trade-off between computation cost and statistical error by selecting the number of randomized trials (“shots”), and it also supports alternative bookkeeping strategies, such as propagating a list of intermediate reduced operators forward one gate at a time or recomputing reduced operators from the original M to a selected circuit location. This is in line with the above-described trade-off in lightcone selection, minimizing a combination of total bias and variance, over minimizing the bias itself.

Determining whether the mean influence is below a tolerance may be expressed as deciding whether a quantity u is less than ϵ, where the sampled grades provide an empirical estimate. The technique according to some embodiments of the present disclosure may determining if additional trials/shots are needed in accordance with the average of (1−g). for example, if the average of (1−g) is O(ϵ) then more trials may be needed. Moreover, even in an extreme case (e.g., all observed grades are zero) a nonzero probability of observing g=1 without enough samples may not be excluded.

A further exemplary direction for determining a bias bound uses the definition of qᵢ=1−gᵢ, and using q̅ as the empirical average of the qᵢ over n trials. Hoeffding-style reasoning suggests that concluding u<ϵ is unlikely if q̅>ϵ and if the quantity exp(−2n(q−ϵ)²) is negligible. This is also described by Bernstein's inequality, yielding a bound of the form: exp(−(n(q−ϵ)\hat{ }2)/(2σ\hat{ }2+1/3(q−ϵ))), where σ² is an empirical or assumed variance. Similarly, concluding u>ϵ is unlikely if q<ϵ and the expression exp(−(n(ϵ−q)\hat{ }2)/(2σ\hat{ }2+1/3(ϵ−q))) is negligible. These inequalities provide an explicit quantitative basis for selecting n (shots) to reach a desired confidence level for including or excluding a gate from an effective lightcone.

The randomized propagation method may relate back to analytic bounds by interpreting the randomized compression as estimating how much a gate's influence survives through later circuit dynamics.

More specifically, given that some quantum circuit are aimed at calculating the expectation value of some local observable O at its end, and assuming that some noise term ξ may act at some specific place in the circuit, it is advantageous to know how much such noise can affect the result one finds for [symbol] . For example, this may be associated with the question to what extent a specific gate g can affect [symbol] . Mathematically the two questions are equivalent since one can consider the ‘noise’ ξ to be something whose effect is to cancel a specific gate, replacing ξ=g⁻¹.

To answer this question, it is enough to know only the part of the circuit which lives in the intersection of J₊(ξ), i.e., the forward light cone of ξ, and J₋(O), i.e., the backward lightcone of O. Generally, as indicated herein ‘lightcone’ can refer to any causality lightcone including forward and backward lightcone, and further including the connectivity lightcone or any smaller one identified or defined using one or more embodiments of the present disclosure.

Further, a basic way to identify the level in which a gate, or noise, affects the observable may include evolving the noise (ξ) forward and/or (O) backwards through layers of the circuit to identify expressions of both at the same intermediate time ξ_{τ}, O_{τ}, or to estimate ∥[ξ_{τ}, O_{τ}]∥. The main difficulty with this is that the calculation of ξ_{τ}, O_{τ} may be very costly.

As noted above, this calculation can be simplified using the fact that only inside the lightcones intersecting J₊(ξ)∩J₋(O) are actually relevant. This allow to simply ignore all other gates of the circuit. Evolving ξ forward (or similarly O backwards), the effective operator ξ_{τ} receives a support which grows monotonically with τ. By its definition, this support always remains inside J₊(ξ), being the forward lightcone of ξ, while it may develop a nontrivial part outside J₋(O), the backward lightcone of O. It may be physically obvious that this part should not be relevant to the final result on noise/gate affecting the observable.

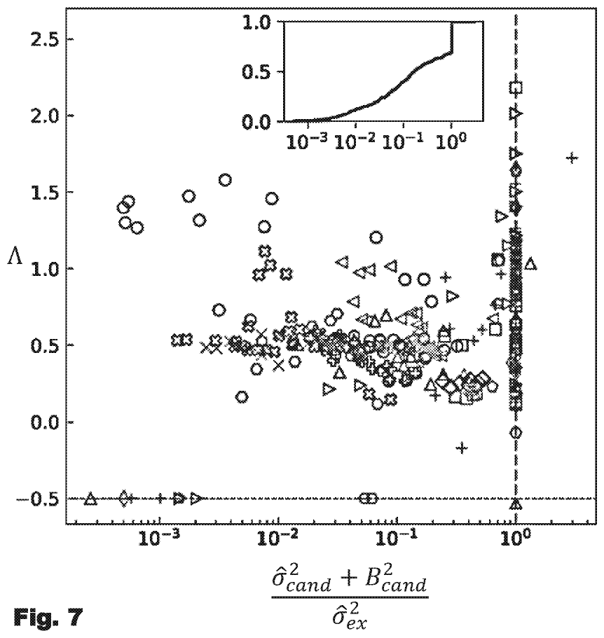

In this connection FIG. 8 schematically illustrates gates located inside the lightcones intersecting J₊(ξ)∩J₋(O), which, for purposes of estimating influence on an objective, only a restricted set of circuit interactions may be relevant, and that this restriction can be expressed as an overlap between (i) a region reachable by forward propagation from a selected gate or unitary error term and (ii) a region obtained by backward propagation from the objective. In some embodiments, the randomized propagation described in Section 8 is applied only within such a restricted region, thereby reducing classical cost while still producing influence estimates suitable for lightcone determination and or lightcone-based bias bounding.

The following relates to the mathematical basis for this analysis. Assuming ξ_{τ} is written in the form Σᵢ Sᵢ ⊗Eᵢ where Sᵢ corresponds to the part acting inside J₋(O), the backwards lightcone of O and Σᵢ acts outside it. In some embodiments, eliminating the degrees of freedom outside the lightcone may include determining density matrix by tracing over an environment. The analogous structure is then

$$\sum {S}_{i} ⊗ {S}_{j}^{†} T r ( {E}_{i} {E}_{j}^{†} ) ,$$

which contains all of the relevant information. If the dimensionality of E is much larger than that of S, then calculating this instead of Σᵢ Sᵢ ⊗Eᵢ provides a great improvement in the complexity of calculation and the amount of memory used. The disadvantage of this is that the dimensionality of S⊗S scales as (dim(S))² rather then as dim(S) which can be significant if dim(S) is not very small. Similar difficulty appears often in standard simulations of open quantum systems. A known way to remedy this is by using the method of ‘quantum trajectories’.

Certain analogous quantum trajectory use according to some embodiments of the present disclosure may be somewhat simpler than the standard one thanks to the fact that the time parameter in the quantum circuit is discrete. It consists of tracing out E probabilistically by (i) choosing some orthonormal basis for the space of operators acting on E; taking the elements of this basis as the {Eᵢ}'s in the expansion ξ_{τ}=>Σᵢ Sᵢ ⊗Eᵢ; associating the probability

$${‖ {S}_{i} ‖}_{F}^{2}$$

with i and randomly selecting one of the Sᵢ according to this probability distribution; and finally replacing ξ_{τ} with a normalized version of the chosen Sᵢ. The average result can then be guaranteed to coincide with the correct one. In some embodiments, the normalization comprises dividing the selected Sᵢ by ∥Sᵢ∥_{F}.

Each step of evolving ξ forward, or Ô backwards, typically includes moving the previous (t=τ−1) expression through the τth layer and then tracing out its irrelevant part, either by a density-matrix based method or a quantum-trajectory based method. In some embodiments, the “moving” comprises conjugating the operator by one or more gates in the τth layer, and the “irrelevant part” comprises the operator component acting outside a selected backward lightcone J₋(Ô) or outside an intersection region described below.

If the two lightcones J₊(ξ) and J₋(Ô) have the same angle of expansion, similar to the common situation known from Minkowski space, and as exemplified in FIG. 8, then their intersection is a strip of constant width. Generally, this may be expected, for example, in the case of uniform circuits. In this case the traced out object

$${\sum }_{i , j} {S}_{i} ⊗ {S}_{j}^{†} T r ( {E}_{i} {E}_{j}^{†} )$$

retains constant size in terms of dimensionality or the number of qubits it involves while evolving as function of the time τ. If Ô and ξ are close to the boundary of each other's lightcone then the width of the intersection region can be quite small, which makes it very feasible to calculate their evolution for τ as long as needed at a relatively low cost. If the angles of expansion are different, the above approach may be less advantageous, but can still provide good results at a reasonable cost. In some embodiments, the “width” corresponds to a bounded number of qubits in the intersection region, thereby bounding classical memory and arithmetic cost for tracing and propagation.

The full operator ξ_{τ}=Σᵢ Sᵢ ⊗Eᵢ obtained by evolving ξ may typically have support on the whole of J₊(ξ). The fact that the relevant region, being the intersection of the two lightcones, is often much smaller (dim(S)<<dim(E)) makes it quite plausible that the S-part can be close to trivial (i.e. ξ_{τ}≈I⊗E, where I is an identity operator acting on the subsystem associated with S and E is an operator acting on the complementary subsystem). In such cases, it is clear that ξ has almost no effect on [symbol] and there is no need to continue calculating it for larger τ. If ξ corresponds to some circuit gate g, it can be dropped from the backward lightcone J₋(Ô). Similar method may be used while evolving Ô backwards in time. Such evolution gives Ô_{τ}=Σᵢ Sᵢ ⊗Eᵢ where Sᵢ is the part inside the lightcone of ξ and Eᵢ is the part outside the lightcone. If this is equal, or almost equal, to I⊗E then ξ and the complete J₋(Ô_{τ}) can be dropped out of the backward lightcone J₋(Ô). In some embodiments, “almost equal” is evaluated using a selected norm and a threshold parameter (for example, ∥Ô_{τ}−I⊗E∥≤ϵ).

Dropping gates g as described above results in replacing the J₋(Ô) lightcone by a version having smaller area in terms of gates. Since knowledge of J₋(Ô) (or at least some upper bound of it) was used in the above procedure it seems that we get an iterative procedure where each reduction of the lightcone J₋(Ô) helps in looking for the next one. We are much less interested in reducing J₊(ξ) because typically there are too many independent noise channels ξ (as opposed to a single objective operator Ô) acting at different places, to make calculation of each J₊(ξ) worthwhile. One negative result of reducing only J₋(Ô) is that after a few steps of it, its angle of expansion becomes smaller than that of J₊(ξ) which as explained earlier can lead to making subsequent iterations more expansive. In some embodiments, this tradeoff is addressed by bounding propagation using a connectivity region (for example, a forward connectivity region associated with g) or by limiting support growth during propagation, thereby keeping per-iteration cost bounded even when the lightcone angles differ.

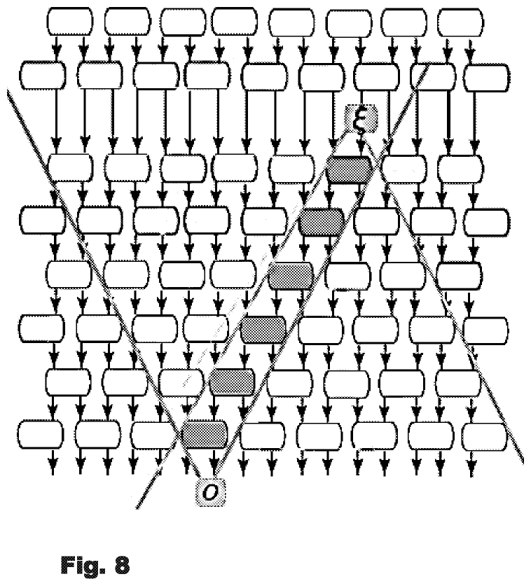

FIG. 9 schematically illustrates the basic randomized propagation/compression step. In the illustrated example, an operator on a smaller subsystem is conjugated through a multi-qubit gate (for example, a′=b⁻¹ab), which generally expands the operator support. A reduction operation (for example, a partial trace over one or more qubits outside the retained subsystem, followed by normalization) is then applied to obtain a reduced operator M′ used for continued propagation. FIG. 9 further illustrates associating a grade g=d Tr(M′²) with the reduced operator M′, where g quantifies how close M′ is to an identity operator on the retained subsystem and therefore how much information about earlier gates is expected to remain.

Consider gates a, b, and c on the edge of the connectivity lightcone J₋(O) (of an observable O) as shown on the left side of FIG. 9. It is clear that this (sub-) circuit (on the left side) is equivalent to the one shown on the right of FIG. 9. Moving gate a beyond gate b at the price of replacing it by a′=b⁻¹ab results in turning it from a two-qubit gate into a three-qubit gate, i.e. operating on qubits 1, 2, and 3, where qubits 2 and 3 are operated on by gate b as exemplified in the figure. While this may appear to be a high price to pay (in terms of additional complexity) and may appear to get worse if one attempts to move it further beyond gate c, the practical price can be substantially lower than it first appears.

FIG. 9 further illustrates the part that is inside the connectivity lightcone J₋(O) using thick lines, and the parts outside the lightcone with thinner lines. This illustrates that only one of the three lines outputting of the gate a′=b⁻¹ab is inside the connectivity lightcone and are illustrated by a thick line. Accordingly, the exact details of thin lines 1 and 2 are not needed for evaluating the influence of gate a on the measurement of O. This reduces computation complexity and memory requirements of the analysis.

As a′ is a three-qubit operator it is natural to expand it as a′=α_{μνλ}σ_{μ}⊗σ_{ν}⊗σ_{λ}. Further, as exemplified in FIG. 9, only the part of a′ acting on the leftmost qubit may actually be relevant for calculation. Accordingly, it is convenient to write a′=σ_{μ}⊗ξ_{μ} where ξμ=α_{μνλ}σ_{ν}⊗σ_{λ}. The operator ξ_{μ} need not be computed explicitly, instead, the relevant quantity can be determined as the inner-product matrix (metric),

$${g}_{μν} = 〈 {ξ}_{μ}^{†} , {ξ}_{ν} 〉 .$$

This operation works by moving a′ beyond the next gate c, turning it into a four-qubit gate a″=(c⁻¹(I⊗σ_{μ})c)⊗ξ_{μ}. Expanding c⁻¹(I⊗σ_{μ})c=σ_{ν}⊗ζ_{μν} (for single-qubit operators (ζ_{μν}) leads to an expansion of a″ as a″=σ_{ν}⊗(ζ_{μν}⊗ξ_{μ}). This expansion is similar to the expansion for a′ except that in this case ξ_{ν} [symbol] ζ_{μν}⊗ξ_{μ}, and therefore

$${g}_{{νν}^{′}} ↦ {g}_{μ , {μ}^{′}} 〈 {ζ}_{μν}^{†} , {ζ}_{{μ}^{′} {ν}^{′}} 〉 .$$

After calculating the updated g_{μν} for a″ the procedure again has the same form of representation and the same type of tracked information as for a′. Thus, this action can be repeated, moving a further through successive gates along the edge of the lightcone, without increasing the dimensionality of the tracked object beyond the metric g_{μν}.

In some cases, after moving the gate a certain level down the circuit, it is determined that ξ₁, ξ₂, ξ₃=0, i.e., if the metric guy becomes concentrated on the subspace μ=0. This indicates that gate a can be safely removed from the lightcone. In this context it may be convenient to normalize the inner product of operators such that the norm square of the identity equals one (rather than the space dimension). If this convention is adopted then unitarity of the gates implies that Tr(g)=1. The potential of a to affect the measurement result is then quantified by (1−g₀₀)=g₁₁+g₂₂+g₃₃. Accordingly, the effect of the gate a may be treated as negligible if this quantity falls below a selected threshold.

If the environment on which ξ_{μ} acts is in a completely random initial state (i.e., completely mixed), then the action of a=σ_{μ}⊗ξ_{μ} on the system is described by the channel ρ [symbol] g_{μν}σ_{μρ}σ_{ν}. A state ρ=|ψ [symbol] ψ| remains unchanged by this with probability g_{μν} [symbol] ψ|σ_{μ}|ψ [symbol] ψ|σ_{ν}|ψ [symbol] , which when averaged over ψ turns into

$$\frac{1}{3} + \frac{2}{3} {g}_{00} .$$

For a nonrandom initial state |x [symbol] of the environment the probability that it does not affect the state of the system is similarly found to be

$${\frac{1}{3} + \frac{2}{3} ‖ {ξ}_{0} \vert x 〉 ‖}^{2} .$$

The average error probability depends only on g₀₀, but the worst-case probability depends on the minimal singular value of ξ₀, which need not be directly determined here. By way of non-limiting example, if the environment Hilbert space has dimension d then the minimal singular value may be lower bounded by \\sqrt{1−(1−g_{0,0})d}.

Similar treatments of gates (or errors) at distance d from the edge of the connectivity lightcone may be performed. The difficulty is that, as gate a is moved downward in the circuit, the number of thick lines, associated with output qubits included in the lightcone, exiting it increases up to a finite value proportional to d. Thus, in the expansion a′=σ_{μ}⊗ξ_{μ′}, the term σ_{μ} may relate to multi-qubit Pauli operators acting on ∝d qubits. Accordingly, as expected, the associated complexity grows with d.

The recursion relation for g_{μν} has the form

$${g}_{μν}^{′} = {Z}_{μν}^{λ τ} {g}_{λ τ}$$

(written formally as g′=Z*g) for a tensor Z determined solely by the gate over which the propagation step is performed. The effective Z corresponding to a portion of the lightcone edge is the ★-product of the Z-tensors of the gates sitting there. Calculating such a product is sufficient to compute the effect of noise terms acting on the lightcone edge at distance from the point of measurement. A noise term acting there does not affect the measurement if

$${Z}_{i j}^{μν} = 0 ∀ i ,$$

j≠0. Equivalently, if

$${Z}_{00}^{μν} = {δ}^{μν} .$$

By its definition the Z-tensor is a positive map, and its inverse is typically not positive.

When the gate b is described by U∈SU(4) one can write

$${Z}_{μν}^{λ τ} = \frac{1}{{2}^{4}} {\sum }_{κ} Tr ( U ( {σ}_{μ} ⊗ {σ}_{κ} ) {U}^{†} ( I ⊗ {σ}_{λ} ) ) Tr ( U ( {σ}_{ν} ⊗ {σ}_{κ} ) {U}^{†} ( I ⊗ {σ}_{τ} ) )$$

In the treatment of errors occurring a distance d from the edge of the connectivity lightcone, it is possible to write a similar formula. In that case U is a direct product of n~O(d/2) elements of SU(4) rather than an arbitrary element of SU(4ⁿ), which allows simplification of the corresponding Z tensor. This tensor-product structure can be lost once one starts multiplying $\star$-products corresponding to consecutive layers.

Given the KAK decomposition of the gate U∈SU(4) one obtains a corresponding decomposition of Z★. Writing the KAK decomposition as U=(V₄⊗V₃)A(V₂⊗V₁) where Vᵢ∈SU(2) and A=exp(Σxᵢσᵢ ⊗σᵢ), the corresponding Z-tensor of U is related to the tensor associated with A by

$${Z}_{μν}^{λ κ} = {( {R}_{2} )}_{{μ}^{′} μ} {( {R}_{2} )}_{{ν}^{′} ν} {( {R}_{3} )}_{λ {λ}^{′}} {( {R}_{3} )}_{τ {τ}^{′}} {( {Z}_{A} )}_{{μ}^{′} {ν}^{′}}^{{λ}^{′} {τ}^{′}} ,$$

where R₂ and R₃ are the three-dimensional rotation matrices (represented by 4×4 matrices) corresponding to the SU(2) elements V₂, V₃.

The action of Z_{A} on the nondiagonal g₋μν terms multiplies each of them by a constant as

$$( \begin{matrix}{g}_{0 , 1} \to {g}_{0 , 1} sin ( 2 {x}_{2} ) sin ( 2 {x}_{3} ) \\ {g}_{0 , 2} \to {g}_{0 , 2} sin ( 2 {x}_{1} ) sin ( 2 {x}_{3} ) \\ {g}_{0 , 3} \to {g}_{0 , 3} sin ( 2 {x}_{1} ) sin ( 2 {x}_{2} ) \\ {g}_{1 , 2} \to - {g}_{1 , 2} sin ( 2 {x}_{1} ) sin ( 2 {x}_{2} ) cos ( 4 {x}_{3} ) \\ {g}_{1 , 3} \to - {g}_{1 , 3} sin ( 2 {x}_{1} ) sin ( 2 {x}_{3} ) cos ( 4 {x}_{2} ) \\ {g}_{2 , 3} \to - {g}_{2 , 3} sin ( 2 {x}_{2} ) sin ( 2 {x}_{3} ) cos ( 4 {x}_{1} )\end{matrix} )$$

On the diagonal terms Z_{A} acts as

$$( \begin{matrix}\begin{matrix}{g}_{0 , 0} \to {g}_{0 , 0} + {g}_{1 , 1} {cos}^{2} ( 2 {x}_{3} ) {cos}^{2} ( 2 {x}_{2} ) + {g}_{3 , 3} {cos}^{2} ( 2 {x}_{1} ) {cos}^{2} ( 2 {x}_{2} ) + \\ {g}_{2 , 2} {cos}^{2} ( 2 {x}_{1} ) {cos}^{2} ( 2 {x}_{3} )\end{matrix} \\ \begin{matrix}{g}_{1 , 1} \to {g}_{1 , 1} {sin}^{2} ( 2 {x}_{2} ) {sin}^{2} ( 2 {x}_{3} ) + {g}_{2 , 2} {sin}^{2} ( 2 {x}_{1} ) {cos}^{2} ( 2 {x}_{3} ) + \\ {g}_{3 , 3} {sin}^{2} ( 2 {x}_{1} ) {cos}^{2} ( 2 {x}_{2} )\end{matrix} \\ \begin{matrix}{g}_{2 , 2} \to {g}_{2 , 2} {sin}^{2} ( 2 {x}_{1} ) {sin}^{2} ( 2 {x}_{3} ) + {g}_{1 , 1} {sin}^{2} ( 2 {x}_{2} ) {cos}^{2} ( 2 {x}_{3} ) + \\ {g}_{3 , 3} {sin}^{2} ( 2 {x}_{2} ) {cos}^{2} ( 2 {x}_{1} )\end{matrix} \\ \begin{matrix}{g}_{3 , 3} \to {g}_{3 , 3} {sin}^{2} ( 2 {x}_{1} ) {sin}^{2} ( 2 {x}_{2} ) + {g}_{1} , 1 {sin}^{2} ( 2 {x}_{3} ) {cos}^{2} ( 2 {x}_{2} ) + \\ {g}_{2 , 2} {sin}^{2} ( 2 {x}_{3} ) {cos}^{2} ( 2 {x}_{1} )\end{matrix}\end{matrix} )$$

Averaging over all possible U∈SU(4) takes any guy into a diagonal isotropic form by symmetry. Explicit calculation further shows that this averaged Z ★ acts as

$${g}_{0 , 0} ↦ \frac{1}{5} + \frac{4}{5} {g}_{0 , 0} .$$

Thus, for a random circuit, (1−g_{0,0}) decays on average as

$${( \frac{4}{5} )}^{n}$$

after n steps.

Taking the gate U=exp[iα(Z⊗Z)]exp[iβ(X⊗I+I⊗X)] as an example, moving an error term across it takes a given g_{μν} into (Z ★g)_{μν} given by

$$( \begin{matrix}\begin{matrix}{g}_{0 , 0} + {g}_{3 , 3} + \\ ( {g}_{1 , 1} + {g}_{2 , 2} ) {cos}^{2} ( 2 α )\end{matrix} & 0 & 0 & 0 \\ 0 & 0 & 0 & 0 \\ 0 & 0 & \begin{matrix}( {g}_{1 , 1} + {g}_{2 , 2} ) \\ {sin}^{2} ( 2 α ) {sin}^{2} ( 2 β )\end{matrix} & \begin{matrix}\frac{1}{2} ( {g}_{1 , 1} + {g}_{2 , 2} ) \\ {sin}^{2} ( 2 α ) sin ( 4 β )\end{matrix} \\ 0 & 0 & \begin{matrix}\frac{1}{2} ( {g}_{1 , 1} + {g}_{2 , 2} ) \\ {sin}^{2} ( 2 α ) sin ( 4 β )\end{matrix} & \begin{matrix}( {g}_{1 , 1} + {g}_{2 , 2} ) \\ {sin}^{2} ( 2 α ) {cos}^{2} ( 2 β )\end{matrix}\end{matrix} )$$

The only nonzero eigenvalues of Z ★ in this case are λ=1 and λ=sin²(2α)sin²(2β), but it also has one nontrivial 2×2 Jordan block corresponding to λ=0.

Acting k times with Z provides:

$${2}^{k} * g = ( \begin{matrix}1 & 0 & 0 & 0 \\ 0 & 0 & 0 & 0 \\ 0 & 0 & 0 & 0 \\ 0 & 0 & 0 & 0\end{matrix} ) - ( {g}_{1 , 1} + {g}_{2 , 2} ) ( \begin{matrix}1 & 0 & 0 & 0 \\ 0 & 0 & 0 & 0 \\ 0 & 0 & - {sin}^{2} ( 2 β ) & \frac{1}{2} sin ( 4 β ) \\ 0 & 0 & \frac{1}{2} sin ( 4 β ) & - {cos}^{2} ( 2 β )\end{matrix} ) {sin}^{2 k} ( 2 α ) {sin}^{2 ( k - 1 )} ( 2 β )$$

$$( using Tr ( g ) = 1 )$$

Considering a case where a measurement M is applied on a qubit at a selected position in a quantum circuit, for simplicity, the measurement is normalized such that Tr(MM^{†})=1. The qubit (or line) on which the measurement operates may exit a quantum gate, which is typically a two-qubit gate, described by a unitary operator U acting on the qubit and on at least one other qubit.

Pulling the measurement beyond the gate amounts to replacing it the modified measurement M′=U^{†}(M⊗I)U. In general, M′ may act on a number of qubits at the input of the gate. As indicated above, only some of these qubits are of actual interest, and typically only one. To this end, the information regarding the other qubits can effectively be ignored or thrown away.

The steps described herein are mathematically justified only provided that the set of qubits whose information we throw away has a past light cone which does not touch the gates which we intend to investigate. Note that the algorithm described below is well defined even if one ignores this restriction. It is however not justified in this case because it may ignore nontrivial correlations between the discarded qubits and the gates under investigation.

Considering {B_{α}} to be an orthonormal basis of the set of Hermitian operators on the qubit(s) whose information we intend to throw away. One may assume it to be just the standard choice {|i [symbol] j|} to simplify the following. although other and potentially simpler basis choices may be used.

Denoting m_{α}=Tr₂((M′(I⊗B_{α})) and

$${P}_{α} = T r ( {m}_{α} {m}_{a}^{†} ) .$$

The set {P_{α}} are probabilities i.e. non-negative and sum up to 1. Choosing one of the as with probability P_{α}, and replacing M′ by the corresponding

$$g = \frac{1}{d} {Tr ( {M}^{′} )}^{2} ,$$

which acts only on the qubits of interest. This new M′ is associated with the grade

$$g = \frac{1}{d} T {r ( {M}^{′} )}^{2} ,$$

where d is the dimension of the space of the qubits of interest. This grade is in the range [0,1], where a grade=1 means that M′ is the identity operator up to normalization factor. This means that measurement of it contains no information and thus all gates in its past lightcone can be safely ignored. A grade=0 corresponds to the opposite situation, indicating the measurement includes meaningful information. Generally, on average (with respect to the probability distribution {P_{α}}) the grade g coincides with the quantity g_{0,0} defined above.

The basic step described above of moving M through U, and (probabilistically) reducing it to an operator acting on a subset of qubits while calculating its grade may be used as a subroutine in a full algorithm. A specific gate is generally not considered to be in the effective lightcone if there is high certainty that its effect on the expectation value of M is smaller than ε for some small fixed value of ε. To this end some embodiments of the present disclosure may start with the operator M to be measured. Apply operator conversion as described above to obtain a new operator M′ and determine its grade g. Repeat this a selected number of times (shots) to determine an average grade, and determine if the operator is outside the effective lightcone if this average is greater than 1−ε. The number of ‘shots’ needed in order to determine whether [symbol] 1−g [symbol] <ε is discussed further below. In case the gate is determined to be inside the effective lightcone, the method may proceed to verify the following (next) gate by repeating the method actions with respect to the gate. The proper technique may be determined in accordance with selection of efficiency in time or in memory use. Accordingly, the method may maintain list of operators M′ as determined by operator propagation as described above and moving each of the operators through one more gate, or utilize the original operator M and move it through all gates up to a selected layer of interest, and find the resulting grades.

The process may be completed by applying a rule such that, given calculated grades {g₁, g₂, . . . gₙ}, indicated the following actions between: (a) determining the gate as being outside the effective lightcone; (b) determining the gate as being in the light cone, and thus proceeding consider the next gate; or (c) determining the results as inconclusive, indicating the need to acquire more statistics, i.e. calculating gₙ₊₁. Further, taking X=1−g as a random variable with values in [0,1] option (a) may be used given a high certainty that its mean μ= [symbol] X [symbol] is smaller than ε, option (b) may be preferable if μ>ε and (c) otherwise.

A priori, the distribution of μ over [0,1] may not be uniform. For example, for a single two 2 qubit Haar-random gate U, the distribution may be 6(1−\sqrt{1−x})²dx. Generally, uniform distribution may lead to the conclusion that getting μ<ε=0.001 is extremely unreasonable even without performing a single shot. In fact, at least for a large enough random circuit, u may typically tend to be closer to zero than to one, a tendency that becomes stronger as M is propagated through larger and larger number of gates. For example, for a random circuit

$$μ = 1 - {g}_{0 , 0} ∝ {( \frac{4}{5} )}^{n} .$$

A simplified approach may utilize a number of shots, giving grades g₁, g₂, . . . gₙ (and thus Xᵢ=1−gᵢ; i=1 . . . n) to estimate the average grade

$$\overline{X} = \frac{1}{n} ∖ sum X\_i\$$$

to a certainty of approximately

$$O ( \frac{{σ}^{2}}{\sqrt{n}} ) .$$

The variance σ² may be estimated from the spread ΔX of {X₁, X₂, . . . . Xₙ}, and may also be a priory known. It may be useful to note that (since 0≤X≤1) the variance must satisfy σ²≤ [symbol] X² [symbol] ≤ [symbol] X [symbol] =μ. Which implies that the interesting case where μ=O(ε) leads to a small variance allowing better estimation of the mean.

By Hoeffding's inequality the probability of X̅ to be a distance≥t away from the mean μ is bounded by exp(−2 nt²). Further, a version of Bernstein inequality indicates that this probability is bounded by

$$exp ( \frac{- n {t}^{2}}{2 {σ}^{2} + 2 t / 3} ) .$$

If X̅ is determined as not particularly small (i.e. being O(1)) then using the Hoeffding's inequality may reject the possibility μ<ε once exp(−2 nt²) falls below a selected p-value using only n=O(1) shots. If X is small, the denominator

$${σ}^{2} + \frac{2 t}{3}$$

in the Bernstein inequality is expected to be small too, making it a stronger inequality. Further, if X̅<ε, verifying that μ<ε may be desired, the method may typically require

$$n = O ( \frac{1}{ε} ) shots .$$

It should be noted that even in extreme case where all the results X₁, X₂, . . . Xₙ were exactly zero, the possibility that there is a probability of

$$p = O ( \frac{1}{n} )$$

to get X=1, which would increase the mean from 0 to p cannot be excluded.

Additionally, if X̅=(1+ζ)ε with very small ζ then deciding whether μ>ε or μ<ε may be a difficult task. In this case a thumb rule suggests n~ε⁻¹ζ⁻¹ while the rigorous Bernstein inequality gives n~ε⁻¹ζ⁻², which may or may not be an over-estimate.

Numerical simulations with a model of random two qubit gates suggest that the mean and) 0.46 standard deviation of the random variable are roughly related by σ²≃0.77(μ(1−μ))^{0.46}. For a fixed μ the theoretically largest possible variance is obtained for binomial distribution (with X∈{0,1}) having σ²=(μ(1−μ))^{0.5}, which is not very far from the above fit.

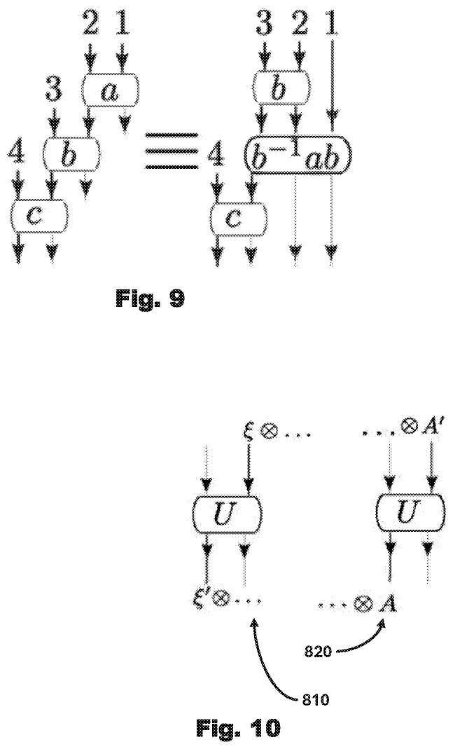

The above analysis is based on moving gates or noise terms forward across levels of the quantum circuit. An almost identical description can be used when the observable is moved backward across levels of the same circuit. Considering a two qubit gate U sitting on the right edge of the lightcone as in FIG. 10, which schematically illustrate an objective operator O that may become entangled, under backward propagation, with operators supported deeper within the lightcone, while a unitary noise term ε propagated forward may become entangled only with degrees of freedom that lie outside the lightcone. This conceptual separation motivates using reduced representations and grade-based decisions: if the reduced operator becomes close to identity (high grade), then earlier operations can be treated as having negligible influence on the objective under the selected tolerance.

A noise term acting before the gate U on its right qubit as ξ (and may be on some other qubits outside of it) is shown to be replaceable by some other term of the form ξ′ ⊗ . . . acting after U. Similarly, an observable O acting after U on its left qubit and possibly on some other qubits left of it is replaceable by some O′ acting before the gate U. If O′ turns out to be the identity/then it may be concluded that the gate above U, which acts on it, is redundant in the sense that it does not affect the result of measurement of O. These two points of view are almost identical. While the modification steps ξ→UξU^{†}, A→U^{†}AU may be similar, the appearance of ξ,A in the construction of the expectation values~Tr(AUξρξ^{†}U^{†}) may be different.

Using the second approach amounts to replacing the operator Z ★ acting on the metric g_{μν} by a closely related operator, noted here \tilde{Z}★ acting on a dual metric dual metric derived from the observable. If the relevant observable just after the gate U is expressed as O=ΣA_{α}⊗σ_{α} where A_{α} acts only on the qubit to the left then the dual metric is defined as

$${\tilde{g}}_{μ μ} = T r ( {A}_{μ} {A}_{ν}^{†} ) .$$

Moving it across U corresponds to acting on \tilde{g}_{μμ} by \tilde{Z} ★.

It can be written that w_{α}=∥A_{α}∥, associating a four index tensor W with a two qubit gate U defining that U^{†}(σ_{μ}⊗σ_{ν})U=W_{μνκλ}(σ_{κ}⊗σ_{λ}). Noting that by unitarity W_{μνκλ}W_{κλθω}=δ_{μθ}δ_{νω}. This can be related to the Z ★ operator through the formula:

$${Z}_{μν}^{λ τ} = {W}_{0 λ μ κ} {W}_{0 τνκ} ,$$

and for the \tilde{Z} ★ operator by:

$${\tilde{Z}}_{μν}^{λ τ} = {W}_{0 λκμ} {W}_{τ0κν} .$$

Using the notation O=ΣA_{α}⊗σα, moving the observable O across the gate U corresponds to

$${O}_{μ} ↦ {O}_{μ}^{′} = {W}_{λ 0 κ μ} {A}_{λ} ⊗ {σ}_{κ}$$

leading to a rule for updating the metric:

$${\tilde{g}}_{μ v} ↦ {\tilde{g}}_{μν}^{′} = {\tilde{Z}}_{μν}^{λ τ} {\tilde{g}}_{λ τ} .$$

For the gate U=exp[iα(Z⊗Z)]exp[iβ(X⊗I+I⊗X)] the relevant nonzero W-coefficients are:

$${W}_{0 , 0 , 0 , 0} = 1 , {W}_{1 , 0 , 1 , 0} = cos ( 2 α ) , {W}_{3 , 0 , 2 , 0} = - sin ( 2 β ) , {W}_{3 , 0 , 3 , 0} = cos ( 2 β ) ,$$

$${W}_{1 , 0 , 2 , 2} = - \frac{1}{2} sin ( 2 α ) sin ( 4 β ) , {W}_{1 , 0 , 3 , 2} = - sin ( 2 α ) {sin}^{2} ( 2 β ) ,$$

$${W}_{1 , 0 , 2 , 3} = sin ( 2 α ) {cos}^{2} ( 2 β ) , {W}_{1 , 0 , 3 , 3} = \frac{1}{2} sin ( 2 α ) sin ( 4 β ) ,$$

$${W}_{2 , 0 , 1 , 2} = sin ( 2 α ) sin ( 2 β ) , {W}_{2 , 0 , 1 , 3} = - sin ( 2 α ) cos ( 2 β ) ,$$

$${W}_{2 , 0 , 2 , 0} = cos ( 2 ∖ alpha ) cos ( 2 β ) , {W}_{2 , 0 , 3 , 0} = cos ( 2 α ) sin ( 2 β ) .$$

The form of these coefficients (specifically having W_{μ,0,ν,1}=O∀μν) provides A₁→0 after one step of moving O through U. (This is reflected in getting w₁=0 and g_{μ1}=g₋1μ=0.) Once A₁=0 the recursion relation for A₂, A₃ becomes quite simple A₂ [symbol] W_{2,0,1,2}A₂ ⊗σ₁, A₃ [symbol] W_{2,0,1,3}A₂⊗σ₁, which implies that ∥A₂∥ and ∥A₃∥ decay as

$${W}_{2 , 0 , 1 , 2}^{n} = {sin}^{n} ( 2 α ) {sin}^{n} ( 2 β )$$

upon moving them through n copies of the gate U. Accordingly, the bounds on w₂, w₃ as well as \sqrt{gᵢⱼ} decay in this fashion.

It should be noted that in this simple and non-limiting example only a single summand (namely λ=2, κ=1) contributed to the expression

$${0}_{μ}^{′} = {W}_{λ 0 κ μ} {A}_{λ} ⊗ {σ}_{κ} .$$

Thus typically no potential cancellations between different summands can occur.

Further, considering the gate U=exp[iα(Z⊗Z)]exp[iβ(S⊗I+I⊗S)] with S=X cos θ+Y sin θ. In this case the recursion relation for the bound on wᵢ may imply that after n applications of the U-gate it scales as xⁿ where x=sin (2α) sin (2β)(sin (2β) sin (2θ)+sin (θ)+cos (θ)). Assuming small enough positive α, β, θ, for larger values the dependence on the parameters may become non-analytic due to the absolute value appearing in the recursion relation. A more general result can be expressed by

$$\frac{x}{\vert sin ( 2 α ) sin ( 2 β ) \vert} = \vert sin ( 2 β ) sin ( 2 θ ) \vert + \vert sin ( θ ) \vert max ( 1 , 4 {sin}^{2} ( β ) {cos}^{2} ( θ ) - 1 ) + \vert cos ( θ ) \vert max ( 1 , 4 {sin}^{2} ( β ) {sin}^{2} ( θ ) - 1 ) .$$

On the other hand using the calculation of the guy metric by construction covariant under local unitaries and therefore its behavior preferably remains independent of O and hence scales as sinⁿ(2α)sinⁿ(2β).

In this context it should be noted that the above estimates of g_{μν} provide an exact calculation of guy rather than merely an upper bound. Indeed by consistency the exact wᵢ typically also scales roughly as sinⁿ(2α)sinⁿ(2β) for arbitrary θ. The bound found for wᵢ may however be much larger (e.g., at θ≠0).

It is also suggested to use similar inequalities to bound wᵢ deep inside the lightcone rather than only near its edge. The bound presented for this is however too crude to be useful. It can be stated that

$${w}_{μ}^{′ L} \leq {\sum }_{λ v κ} \vert {W}_{λ v κ μ} \vert min ( {w}_{λ}^{L} , {w}_{v}^{R} ) , {w}_{κ}^{′ R} \leq {\sum }_{λ v μ} \vert W\_λvκμ \vert min ( {w}_{λ}^{L} , {w}_{v}^{R} ) ,$$

where L, R are left and right of the two qubits on which the gate U acts. Noting that any 4×4 unitary operator provides Σ_{λνκ}|W_{λνκμ}|≥4∀μ, and similarly Σ_{λνμ}|W_{λνκμ}|≥4∀κ. Thus, the resulting upper bound on w may typically grow as 4ⁿ with the number of layers n, and the bound can avoid this behaviour if some of the wᵢ are much smaller than the others. This is what happens at the lightcone right edge where

$${w}_{x}^{R} = {w}_{y}^{R} = {w}_{z}^{{R}_{=}} 0.$$

In some embodiments, the present disclosure relies on the principle that a small deviation in an operator representation implies a correspondingly small deviation in the action induced on an objective operator. To support this, the appendix provides a norm inequality for unitary operators. In particular, for unitary operators U and V, and for an operator A having bounded norm, the appendix shows that the difference between the conjugation actions A [symbol] UAU^{†} and A [symbol] VAV^{†} can be bounded in terms of an operator distance between U and V. In practice, such inequalities support replacing or approximating propagated operators (for example, at a boundary of a candidate lightcone) while controlling the resulting impact on an evaluated objective.

In some embodiments, the present disclosure may utilize sampling-based estimators, including quasi-probability style estimators, and evaluates tradeoffs between variance and bias when restricting mitigation or simulation to a selected lightcone. The appendix therefore provides derivations that express estimator variance using conditioning and decomposition into interpretable components. For example, the appendix derives variance expressions by applying a conditional-variance decomposition that separates (i) variation conditioned on a sampled circuit instance (or sampled mitigation configuration) and (ii) variation arising from the random selection of circuit instances (or mitigation configurations). This supports selecting sampling parameters, confidence intervals, and test thresholds based on analytic variance expressions rather than relying solely on empirical heuristics.

In some embodiments, the present disclosure may utilize decision rules that depend on whether sampled data fall within a designated subset of outcomes or configurations (for example, a subset defined by a difference pattern, a candidate cone, or a nested-cone validation condition). The appendix provides derivations for conditional expectations and conditional variances when estimators are computed only over such subsets. Importantly, the appendix also addresses the practical edge case in which no sampled instance lands in the subset during a finite run, and provides a mathematically consistent treatment of that case, including conditions for unbiasedness and the impact on variance. These results support statistically sound validation procedures for selecting among candidate (including nested) lightcones and for determining whether a candidate cone yields an acceptable bias-variance tradeoff under a selected confidence criterion.

In some embodiments, the techniques described herein may be implemented as a computer-implemented method executed by one or more processors, as a system comprising one or more processors and memory storing instructions, and/or as a non-transitory computer-readable medium storing instructions that, when executed by one or more processors, cause performance of the operations described herein.

In some embodiments, a computer-implemented method may be provided for determining and using a lightcone associated with a selected objective for a quantum circuit. The method may include receiving circuit data describing a quantum circuit, the circuit data including a plurality of circuit layers and gates acting on respective qubits. The method may further include receiving objective data indicative of an objective evaluated at an output of the quantum circuit. The objective data may represent, for example, an expectation value of an observable, an energy estimate for a Hamiltonian (including a sum of terms), an outcome probability, or a mismatch metric derived from measurement results. The method may further include receiving one or more threshold parameters, including a threshold parameter ε and/or a bias budget δ, and optionally receiving noise model data indicative of noise channels associated with gates and/or idle times.

The method may include determining a candidate lightcone using a lightcone construction routine. In some embodiments, determining the candidate lightcone includes performing a layer-by-layer construction that proceeds backward in circuit depth from a measurement layer toward a circuit start layer, and maintaining a sequence of per-layer qubit sets. For a given layer, the method may identify one or more boundary gates having support that intersects a current per-layer qubit set and is not fully contained in the current per-layer qubit set. For a boundary gate, the method may perform an approximate extractability test under the threshold parameter ε. In some embodiments, performing the approximate extractability test includes propagating a representation associated with the boundary gate forward through subsequent layers, while restricting the propagation to gates that (i) are contained within the current candidate lightcone and (ii) intersect a propagated support of the representation. The method may determine that the boundary gate is approximately extractable if one or more criteria are satisfied, including criteria based on approximate commutativity with the objective and/or criteria based on approximation of the propagated representation by an operator of the form I⊗B, where I acts on qubits inside the candidate lightcone and B acts on qubits outside the candidate lightcone. If the boundary gate is not approximately extractable under ε, the method may expand the candidate lightcone by adding at least one qubit of the boundary gate that is outside the current per-layer qubit set, thereby producing an expanding lightcone when viewed backward in time.

The method may include evaluating the candidate lightcone using a Lightcone-Bounds routine.

In some embodiments, evaluating the candidate lightcone includes iterating backward through circuit layers and identifying boundary gates associated with the candidate lightcone. For each boundary gate, the method may compute a per-gate bound by propagating a representation of the boundary gate forward through subsequent layers subject to a propagation constraint, optionally including a maximum-support constraint that limits growth of the propagated support. When propagation reaches the end of the circuit, the method may compute a bound using a commutator-based quantity with respect to the objective. When propagation is halted prior to reaching the end of the circuit, the method may compute a bound using an extractability residual associated with a best approximation of the propagated representation by an operator of the form I⊗B. The method may generate, store, or output per-gate bounds and may aggregate the per-gate bounds to determine a total bias estimate or total bias bound associated with the candidate lightcone.

The method may include selecting among multiple candidate lightcones and/or validating one or more candidate lightcones using nested-cone validation. In some embodiments, the method determines a plurality of candidate lightcones that differ in volume, per-layer qubit sets, and/or included circuit positions. The method may perform a statistical validation procedure using experimental or simulated measurement data to evaluate a bias-variance tradeoff for the candidate lightcones. In some embodiments, the method processes measurement data produced using a quasi-probability error mitigation workflow and uses a decision rule to select a candidate lightcone that is expected to reduce estimator variance more than it increases bias, subject to a selected confidence criterion. The method may apply concentration inequalities and/or variance estimates to determine a number of samples or shots sufficient to accept, reject, or treat as inconclusive a given candidate lightcone under the selected confidence criterion.

The method may further include using a selected lightcone for error mitigation and/or simulation. In some embodiments, the method configures or controls an error mitigation workflow by mitigating noise channels for circuit positions inside the selected lightcone while leaving circuit positions outside the selected lightcone unmitigated, thereby accepting a controlled bias while reducing sampling overhead and estimator variance. In some embodiments, the method configures or controls a classical simulation workflow by omitting, approximating, or otherwise simplifying operations outside the selected lightcone, thereby reducing computational complexity while maintaining a target bias budget.

The method may output one or more results including, for example, a selected lightcone, a list of qubits and/or gates included in the selected lightcone, a ranking of gates based on per-gate influence metrics or bounds, a corrected estimate of the objective, a bias estimate or bias bound, and/or a recommendation of sampling parameters for achieving a target confidence interval.

In some embodiments, the present disclosure provides a system comprising one or more processors and memory storing instructions that, when executed by the one or more processors, cause the system to perform the operations described herein. The system may include one or more interfaces for receiving circuit data describing the quantum circuit, objective data describing the selected objective, and optional noise model data. The system may include a lightcone construction module configured to generate one or more candidate lightcones using a backward, layer-by-layer procedure with approximate extractability tests. The system may include a bounds module configured to compute per-gate bounds and aggregate bounds using the Lightcone-Bounds routine. The system may include a validation module configured to evaluate and select among candidate lightcones using nested-cone validation based on measurement data and statistical decision rules. The system may further include an execution interface configured to provide instructions to a quantum processing unit and/or to a classical simulation engine, including instructions that restrict error mitigation operations or simulation operations to circuit positions inside a selected lightcone. Generally, the system may further comprise a circuitry adapted for operating a quantum circuit but applying selected one or more operations on the quantum circuit as described herein.

In some embodiments, the system may be implemented as a component of a quantum computing stack, a controller for a quantum processor, a classical server or workstation, a cloud-based service, or a combination thereof. In some embodiments, the system performs the lightcone construction, Lightcone-Bounds evaluation, and nested-cone validation using classical computation, and supplies selected lightcone data and mitigation directives to a quantum processor for execution of a restricted error mitigation workflow.

In some embodiments, a non-transitory computer-readable medium stores instructions that, when executed by one or more processors, cause performance of operations including: receiving circuit data and objective data; determining one or more candidate lightcones using a backward, layer-by-layer construction with approximate extractability tests under a threshold parameter; computing per-gate bounds using a forward propagation routine subject to a support constraint; aggregating per-gate bounds to determine a bias estimate or bias bound for a candidate lightcone; statistically validating and selecting a candidate lightcone from among a plurality of candidate lightcones using measurement data and one or more confidence criteria; and using a selected lightcone to restrict error mitigation operations and/or to restrict classical simulation operations, thereby controlling a tradeoff between bias and variance.

In some embodiments, the circuit data includes gate identifiers, layer identifiers, qubit identifiers, and connectivity data, and the candidate lightcone is represented as a sequence of per-layer qubit sets together with a set of gates having support fully or partially within the per-layer qubit sets. In some embodiments, the threshold parameter ε is selected as a bias budget, and the bounds and validation routines are configured to provide bias guarantees under selected norms and selected confidence criteria. In some embodiments, the procedures support mid-circuit measurement, reset, and classically-controlled operations by treating such operations as circuit positions with corresponding propagation and/or bounding rules, and by including such operations within the candidate lightcone when they influence the selected objective.

1. A method for mitigating implementation errors in measurement results of an observable Ô, the implementation errors being associated with a quantum circuit [symbol] , the method comprising:
(a) determining a total bias δ of at least one lightcone LC associated with a quantum circuit [symbol] and an observable Ô; the lightcone LC comprising:
an ordered list of qubit-sets, the qubit-sets corresponding with consecutive gate layers included in the quantum circuit [symbol] ; and
sets of quantum gates corresponding with the consecutive gate layers, each set of quantum gates comprising quantum gates having a respective support set of qubits comprising qubits selected from the ordered list of qubit sets;
wherein determining the total bias δ comprises:
i) for at least one quantum gate g included in the quantum circuit [symbol] and not included in the lightcone LC, computing a gate-propagation and determining at least one propagated gate representation U, the gate-propagation being forward propagation or backward propagation;
ii) computing, from the propagated gate representation U and the observable Ô, a bias contribution term associated with the quantum gate g, and aggregating the bias contribution term to obtain the total bias δ;
(b) operating a quantum processing unit, and executing an implemented version of the quantum circuit [symbol] a plurality of times to obtain measurement data;
(c) measuring, in at least one execution, one or more qubits associated with the observable Ô, to obtain respective measurement results; and
(d) processing the measurement results by applying, in classical post-processing, an error mitigation protocol to determine an estimate value of the observable Ô for an ideal version [symbol] ₀ of the quantum circuit [symbol] , wherein applying the error mitigation protocol comprises applying error mitigation operations to quantum gates within the lightcone LC and omitting error mitigation operations for quantum gates outside the lightcone LC;
wherein the total bias δ is used to select the lightcone LC and/or to set at least one post processing parameter of the error mitigation protocol, and/or to set a number of executions of the quantum circuit [symbol] .

2. The method according to claim 1, wherein the gate-propagation is computed for an ideal version g₀ of the at least one quantum gate g, and wherein the total bias δ is computed according to an ideal version [symbol] ₀ of the quantum circuit [symbol] .

3. The method according to claim 1, wherein:
(a) the corresponding bias contribution term η_{g} is:
i) ∥U−I⊗B*∥ if the gate-propagation is performed with respect to the propagated gate representation U having an associated layer index l greater than one and less than a depth L of the quantum circuit [symbol] , thereby 1<l<L;
ii) ∥[U, Ô]∥ if the gate-propagation is performed forward with respect to the associated layer index l being equal to the depth L; or
iii) ∥[ρ₀, Ô]∥ if the gate-propagation is performed backwards with respect to the associated layer index l being equal to one, wherein po is an initial state of a qubit support of the quantum circuit [symbol] ;
(b)
$${B}^{*} = {arg min}_{\{ B \}} ‖ U - I ⊗ B ‖ ,$$
wherein I is an identity operator having support included in the lightcone LC, and B is an operator having support not included in the lightcone LC;
(c) The norm is any one of: an operator norm, Frobenius norm, and trace norm; and
(d) a qubit-support of B is disjoint from a qubit-set corresponding to gate layer l+1 and included in the lightcone LC.

4. The method according to claim 1, wherein the total bias δ is δ=∥( [symbol] − [symbol] ^{†})(Ô)∥, where [symbol] is an identity super-operator, [symbol] ^{†}= [symbol] , [symbol] ^{†} is an action of a non-ideal implementation of the quantum circuit [symbol] , [symbol] is an action of the ideal version [symbol] ₀ of the quantum circuit [symbol] ; and, wherein the method comprises tensor contraction of [symbol] ^{†} based on a tensor-network representation of MT.

5. The method according to claim 1, wherein for at least one quantum gate Q, a qubit-set, corresponding a gate layer including the at least one quantum gate Q:
(a) comprising at least one qubit included in a support of the at least one quantum gate Q; and
(b) excluding at least one qubit included in a support of the at least one quantum gate Q;
thereby, the lightcone LC comprises a qubit-set comprising qubits corresponding at least one boundary quantum gate, thereby, a boundary of the lightcone LC intersects the at least one quantum gate Q.

6. The method according to claim 1, wherein the at least one quantum gate g is a non-Clifford gate.

7. The method according to claim 1, wherein:
(a) the at least one quantum gate g is included in a predefined lightcone being a connectivity light cone; and,
(b) a connectivity between qubits comprises connections according to a noise model Λ associated with a quantum processing unit and the quantum circuit [symbol] ; and
a support of the at least one quantum gate g is partially included in at least one qubit-set corresponding a gate layer succeeding a gate layer comprising the at least one quantum gate g.

8. The method according to claim 5, comprising iterating over boundary quantum gates, and computing propagation for each boundary quantum gate iterated over.

9. The method according to claim 1, wherein the total bias δ is used to set the at least one post processing parameter of the error mitigation protocol comprising at least one of: a truncation parameter, a regularization parameter, and a number of samples used in the post processing.

10. The method according to claim 1, wherein the total bias δ is used to select the lightcone LC from a plurality of candidate lightcones by rejecting candidate lightcones having total bias δ exceeding a bias threshold δₘₐₓ.

11. A non-transitory computer readable storage medium, storing computer instructions, wherein the computer instructions are used for causing a computer communicating with a quantum processing unit, to implement the method according to claim 1.

12. A method for mitigating implementation errors in measurement results of an observable Ô, the implementation errors being associated with a quantum circuit [symbol] , the method comprising:
computing at least one lightcone LC according to the quantum circuit [symbol] and the observable Ô, the lightcone LC comprising:
an ordered list of qubit sets, the qubit-sets corresponding to consecutive gate layers included in the quantum circuit [symbol] ; and
sets of quantum gates corresponding to the consecutive gate layers, each set of quantum gates comprising quantum gates having support comprising qubits included in a corresponding qubit-set;
wherein computing the at least one lightcone LC comprises:
a) computing a gate-propagation for at least one quantum gate g included in the quantum circuit [symbol] , and obtaining a corresponding at least one propagated gate representation U, the gate-propagation being forward propagation or backward propagation;
b) computing a corresponding bias contribution term η_{g} from the propagated gate representation U and the observable Ô; and
c) selecting, according to the corresponding bias contribution term η_{g}, inclusion in the lightcone LC of:
the quantum gate g, in a set of quantum gates corresponding to a gate layer including the at least one quantum gate g, thereby selecting inclusion of the quantum gate g in the lightcone LC; and
at least one qubit included in a support of the quantum gate g, in a qubit-set corresponding to the gate layer including the at least one quantum gate g;
d) operating a quantum processing unit, and executing an implemented version of the quantum circuit [symbol] a plurality of times to obtain measurement data;
e) measuring at least one qubit associated with the observable Ô, and obtaining measurement results; and
f) processing the measurement results by applying, in classical post processing, an error mitigation protocol to determine an estimated value of the observable Ô for an ideal version [symbol] ₀ of the quantum circuit [symbol] , wherein applying the error mitigation protocol comprises applying error mitigation operations to quantum gates within the lightcone LC and omitting error mitigation operations for quantum gates outside the lightcone LC.

13. The method according to claim 12, wherein selecting inclusion of the quantum gate g in the lightcone LC comprises selecting inclusion when the corresponding bias contribution term η_{g} exceeds a predefined threshold εₜₕ.

14. A method for mitigating implementation errors in measurement results of an observable Ô, the implementation errors being associated with a quantum circuit C, the method comprising:
determining a plurality of candidate lightcones LC^{(j)} associated with the quantum circuit C and the observable Ô, each candidate lightcone LC^{(j)} comprising:
an ordered list of qubit-sets, the qubit-sets corresponding to consecutive gate layers included in the quantum circuit [symbol] ; and
sets of quantum gates corresponding with the consecutive gate layers, each set of quantum gates comprising quantum gates having a respective support set of qubits comprising qubits selected from the ordered list of qubit-sets;
wherein the plurality of candidate lightcones LC^{(j)} comprise at least a first candidate lightcone LC^{(j)} and a second candidate lightcone LC^{(k)} such that all quantum gates included in the first candidate lightcone LC^{(j)} are included in the second candidate lightcone LC^{(k)}, thereby the first candidate lightcone LC^{(j)} being nested in the second candidate lightcone LC\hat{ }((k));
operating a quantum processing unit, and executing an implemented version of the quantum circuit [symbol] a plurality of times to obtain measurement data;
measuring, in each execution, one or more qubits associated with the observable Ô to obtain respective measurement results;
for each candidate lightcone LC^{(j)} processing the measurement results by applying, in classical post processing, an error mitigation protocol to determine a respective estimated value of the observable Ô for an ideal version [symbol] ₀ of the quantum circuit [symbol] , wherein applying the error mitigation protocol comprises applying error mitigation operations to quantum gates within the candidate lightcone LC^{(j)} and omitting error mitigation operations for quantum gates outside the candidate lightcone LC^{(j)};
for each candidate lightcone LC^{(j)} determining an estimated variance and a total bias associated with the respective estimated value; and
selecting a selected lightcone from the plurality of candidate lightcones LC^{(j)} by minimising the estimated variance subject to the total bias satisfying a bias criterion, and outputting the respective estimated value associated with the selected lightcone.

15. The method according to claim 14, wherein the candidate lightcones LC^{(j)} are nested such that, for each of a plurality of consecutive gate layers, a qubit-set of LC^{(j)} is a subset of a corresponding qubit-set of LC^{(k)}.

16. The method according to claim 14, wherein the bias criterion comprises δ≤δₘₐₓ.

17. The method according to claim 14, wherein determining the respective estimated values for the plurality of candidate lightcones LC^{(j)} is performed using the same measurement results obtained from executing the implemented version of the quantum circuit [symbol] .

18. The method according to claim 14, wherein the method operates to identify a difference region between a reference lightcone and a candidate lightcone, the difference region including circuit positions that are inside the reference lightcone and outside the candidate lightcone, and to estimate a quantitative bias contribution associated with the difference region using a common quasi-probability dataset.

19. The method according to claim 18, wherein the common quasi-probability dataset comprises, for each shot:
i) an indication of which quasi-probability-modified circuit instance was executed; and
ii) a corresponding measurement outcome.

20. The method according to claim 14, wherein selecting the selected lightcone comprises selecting, among the plurality of candidate lightcones LC^{(j)} a lightcone having a smallest corresponding bias δ subject to a variance criterion.
